(19) United States
(12) Patent Application Publication
(10) Pub. No.: US 2024/0225354 A1
(43) Pub. Date: Jul. 11, 2024

(54) RECONFIGURABLE BARBEQUE COOKER

(71) Applicants: Larry Vansickel, Phoenix, AZ (US); Hai Wang, Ningbo (CN)

(72) Inventors: Larry Vansickel, Phoenix, AZ (US); Hai Wang, Ningbo (CN)

(21) Appl. No.: 18/094,239

(22) Filed: Jan. 6, 2023

(51) Int. Cl. A47J 37/07; A47J 37/04; F24B 1/193

(52) U.S. Cl. CPC A47J 37/0731; A47J 37/041; A47J 37/0704; F24B 1/193

(57) ABSTRACT

A barbeque cooker in which the food stays at a predetermined level and a fire tray assembly can be adjusted as to vertical position relative to the food. The fire tray assembly includes two spaced apart parallel fire trays (for holding burning fuel) that are independently adjustable as to horizontal position. Vertical and horizontal adjustments are accomplished with hand cranks making for precise adjustments. The vertical adjustment hand crank operates a scissor jack assembly. A drip tray is attached to the top of the scissor jack assembly. The fire tray assembly is attached to and vertically spaced apart from the drip tray, allowing space for the horizontal adjustment screws. The scissor jack assembly is attached to front and rear end frames, each having a top portion configured to support a rotisserie and to support a grill. Two embodiments are presented, having different configurations of the horizontal adjustment screw assemblies.

### FIELD OF ART

The present invention relates to barbeque grills for cooking food. The present invention more particularly relates to a barbeque grill having two fire trays that can be repositioned by a user vertically and/or horizontally beneath a grill or rotisserie.

### BACKGROUND OF THE INVENTION

Traditional barbeque cookers have a fixed fire tray and a grill or rotisserie that can be placed at one or more heights above the fire tray. Moving the grill or rotisserie once the food is mounted thereon can be awkward and dangerous. Traditionally, fat from the grill or rotisserie falls into the fire, creating flare ups that are dangerous and undesirable. Adjustments in the relationship of the food and the fire are limited in conventional rotisseries.

### SUMMARY OF THE INVENTION

The present invention provides a barbeque cooker in which the food stays at a predetermined level and the fire tray assembly can be adjusted as to vertical position relative to the food. The fire tray assembly includes two spaced apart parallel fire trays (for holding burning fuel) that are independently adjustable as to horizontal position. Vertical and horizontal adjustments are accomplished with hand cranks turning threaded posts (screws) each engaging one threaded bore, making for smooth and precise adjustments. A minimal gap is maintained between the two fire trays to allow fat from food on a rotisserie to fall into a drip tray. The vertical adjustment hand crank rotates a threaded post to operate a scissor jack assembly having the drip tray attached to the top of the scissor jack assembly. The fire tray assembly is attached to and vertically spaced apart from the drip tray, allowing space for the horizontal adjustment screws. The scissor jack assembly is attached to front and rear end frames, each of which has a top portion configured to support a rotisserie and to support a grill. The barbeque cooker is preferably made of steel. Two embodiments are presented, differing only in the configuration of the horizontal adjustment screw assemblies.

### DESCRIPTION OF THE FIGURES OF THE DRAWINGS

The present invention will hereinafter be described in conjunction with the following drawing figures, wherein like numerals denote like elements, and

FIG. 1 is a front/side perspective view illustrating an exemplary first embodiment of a barbeque cooker in a first configuration, according to a preferred embodiment of the present invention;

FIG. 2 is a rear/side perspective view illustrating the exemplary first embodiment of the barbeque cooker in a first configuration of FIG. 1, according to a preferred embodiment of the present invention;

FIG. 3 is a top plan view illustrating the exemplary first embodiment of the barbeque cooker of FIG. 1, according to a preferred embodiment of the present invention;

FIG. 4 is a bottom plan view illustrating the exemplary first embodiment of the barbeque cooker of FIG. 1, according to a preferred embodiment of the present invention;

FIG. 5 is a right-side elevation view illustrating the exemplary first embodiment of the barbeque cooker of FIG. 1, according to a preferred embodiment of the present invention;

FIG. 6 is a left side elevation view illustrating the exemplary first embodiment of the barbeque cooker of FIG. 1, according to a preferred embodiment of the present invention;

FIG. 7A is a front elevation view illustrating the exemplary first embodiment of the barbeque cooker of FIG. 1, according to a preferred embodiment of the present invention;

FIG. 7B is a front elevation view illustrating some details of the exemplary first embodiment of the barbeque cooker of FIG. 1, according to a preferred embodiment of the present invention;

FIG. 7C is a diagrammatic view illustrating a side view of the left horizontal position hand crank inner screw bracket of the exemplary first embodiment of the barbeque cooker of FIG. 1, according to a preferred embodiment of the present invention;

FIG. 8 is a rear elevation view illustrating the exemplary first embodiment of the barbeque cooker of FIG. 1, according to a preferred embodiment of the present invention;

FIG. 9A is a front/side perspective view illustrating a second exemplary embodiment of the barbeque cooker in a second configuration, according to a preferred embodiment of the present invention;

FIG. 9B is a side elevation detail view illustrating the second exemplary embodiment of the barbeque cooker of FIG. 9A in a second configuration, according to a preferred embodiment of the present invention;

FIG. 9C is a side elevation detail view illustrating the second exemplary embodiment of the barbeque cooker of FIG. 9A in a second configuration, according to a preferred embodiment of the present invention;

FIG. 10 is a rear/side perspective view illustrating the second exemplary embodiment of the barbeque cooker of FIG. 9A in the second configuration, according to a preferred embodiment of the present invention;

FIG. 11 is a top plan view illustrating the second exemplary embodiment of the barbeque cooker of FIG. 9A in the second configuration, according to a preferred embodiment of the present invention;

FIG. 12 is a bottom plan view illustrating the second exemplary embodiment of the barbeque cooker of FIG. 9A in the second configuration, according to a preferred embodiment of the present invention;

FIG. 13 is a right side elevation view illustrating the second exemplary embodiment of the barbeque cooker of FIG. 9A in the second configuration, according to a preferred embodiment of the present invention;

FIG. 14 is a left side elevation view illustrating the second exemplary embodiment of the barbeque cooker of FIG. 9A in the second configuration, according to a preferred embodiment of the present invention;

FIG. 15 is a front elevation view illustrating the second exemplary embodiment of the barbeque cooker of FIG. 9A in the second configuration, according to a preferred embodiment of the present invention;

FIG. 16 is a rear elevation view illustrating the second exemplary embodiment of the barbeque cooker of FIG. 9A in the second configuration, according to a preferred embodiment of the present invention;

FIG. 17 is a front/side perspective view illustrating exemplary first embodiment of the barbeque cooker of FIG. 1 in a third configuration, according to a preferred embodiment of the present invention;

FIG. 18 is a rear/side perspective view illustrating the exemplary first embodiment of the barbeque cooker of FIG. 1 in the third configuration, according to a preferred embodiment of the present invention;

FIG. 19 is a top plan view illustrating the exemplary first embodiment of the barbeque cooker of FIG. 1 in the third configuration, according to a preferred embodiment of the present invention;

FIG. 20 is a bottom plan view illustrating the exemplary first embodiment of the barbeque cooker of FIG. 1 in the third configuration, according to a preferred embodiment of the present invention;

FIG. 21 is a right side elevation view illustrating the exemplary first embodiment of the barbeque cooker of FIG. 1 in the third configuration, according to a preferred embodiment of the present invention;

FIG. 22 is a left side elevation view illustrating the exemplary first embodiment of the barbeque cooker of FIG. 1 in the third configuration, according to a preferred embodiment of the present invention;

FIG. 23 is a front elevation view illustrating the exemplary first embodiment of the barbeque cooker of FIG. 1 in the third configuration, according to a preferred embodiment of the present invention;

FIG. 24 is a rear elevation view illustrating the exemplary first embodiment of the barbeque cooker of FIG. 1 in the third configuration, according to a preferred embodiment of the present invention;

FIG. 25 is a front/side perspective view illustrating the exemplary first embodiment of the barbeque cooker of FIG. 1 in a fourth configuration, according to a preferred embodiment of the present invention;

FIG. 26 is a rear/side perspective view illustrating an exemplary first embodiment of the barbeque cooker of FIG. 1 in the fourth configuration, according to a preferred embodiment of the present invention;

FIG. 27 is a top plan view illustrating the exemplary first embodiment of the barbeque cooker of FIG. 1 in the fourth configuration, according to a preferred embodiment of the present invention;

FIG. 28 is a bottom plan view illustrating the exemplary first embodiment of the barbeque cooker of FIG. 1 in the fourth configuration, according to a preferred embodiment of the present invention;

FIG. 29 is a right-side elevation view illustrating the exemplary first embodiment of the barbeque cooker of FIG. 1 in the fourth configuration, according to a preferred embodiment of the present invention;

FIG. 30 is a left side elevation view illustrating the exemplary first embodiment of the barbeque cooker of FIG. 1 in the fourth configuration, according to a preferred embodiment of the present invention;

FIG. 31 is a front elevation view illustrating the exemplary first embodiment of the barbeque cooker of FIG. 1 in the fourth configuration, according to a preferred embodiment of the present invention;

FIG. 32 is a rear elevation view illustrating the exemplary first embodiment of the barbeque cooker of FIG. 1 in the fourth configuration, according to a preferred embodiment of the present invention;

FIG. 33 is a front/side perspective view illustrating exemplary first embodiment of the barbeque cooker of FIG. 1 in a fifth configuration, according to a preferred embodiment of the present invention;

FIG. 34 is a rear/side perspective view illustrating the exemplary first embodiment of the barbeque cooker of FIG. 1 in the fifth configuration, according to a preferred embodiment of the present invention;

FIG. 35 is atop plan view illustrating the exemplary first embodiment of the barbeque cooker of FIG. 1 in the fifth configuration, according to a preferred embodiment of the present invention;

FIG. 36 is a bottom plan view illustrating the exemplary first embodiment of the barbeque cooker of FIG. 1 in the fifth configuration, according to a preferred embodiment of the present invention;

FIG. 37 is a right-side elevation view illustrating the exemplary first embodiment of the barbeque cooker of FIG. 1 in the fifth configuration, according to a preferred embodiment of the present invention;

FIG. 38 is a left side elevation view illustrating the exemplary first embodiment of the barbeque cooker of FIG. 1 in the fifth configuration, according to a preferred embodiment of the present invention;

FIG. 39 is a front elevation view illustrating the exemplary first embodiment of the barbeque cooker of FIG. 1 in the fifth configuration, according to a preferred embodiment of the present invention;

FIG. 40 is a rear elevation view illustrating the exemplary first embodiment of the barbeque cooker of FIG. 1 in the fifth configuration, according to a preferred embodiment of the present invention;

FIG. 41 is a front/side perspective view illustrating the exemplary first embodiment of the barbeque cooker of FIG. 1 in a sixth configuration, according to a preferred embodiment of the present invention;

FIG. 42 is a rear/side perspective view illustrating the exemplary first embodiment of the barbeque cooker of FIG. 1 in the sixth configuration, according to a preferred embodiment of the present invention;

FIG. 43 is a top plan view illustrating the exemplary first embodiment of the barbeque cooker of FIG. 1 in the sixth configuration, according to a preferred embodiment of the present invention;

FIG. 44 is a bottom plan view illustrating the exemplary first embodiment of the barbeque cooker of FIG. 1 in the sixth configuration, according to a preferred embodiment of the present invention;

FIG. 45 is a right side elevation view illustrating the exemplary first embodiment of the barbeque cooker of FIG. 1 in the sixth configuration, according to a preferred embodiment of the present invention;

FIG. 46 is a left side elevation view illustrating the exemplary first embodiment of the barbeque cooker of FIG. 1 in the sixth configuration, according to a preferred embodiment of the present invention;

FIG. 47 is a front elevation view illustrating the exemplary first embodiment of the barbeque cooker of FIG. 1 in the sixth configuration, according to a preferred embodiment of the present invention;

FIG. 48 is a rear elevation view illustrating the exemplary first embodiment of the barbeque cooker of FIG. 1 in the sixth configuration, according to a preferred embodiment of the present invention; and

FIG. 49 is an exploded view illustrating the exemplary first embodiment of the barbeque cooker of FIG. 1 in the sixth configuration, according to a preferred embodiment of the present invention.

### DETAILED DESCRIPTION OF THE INVENTION

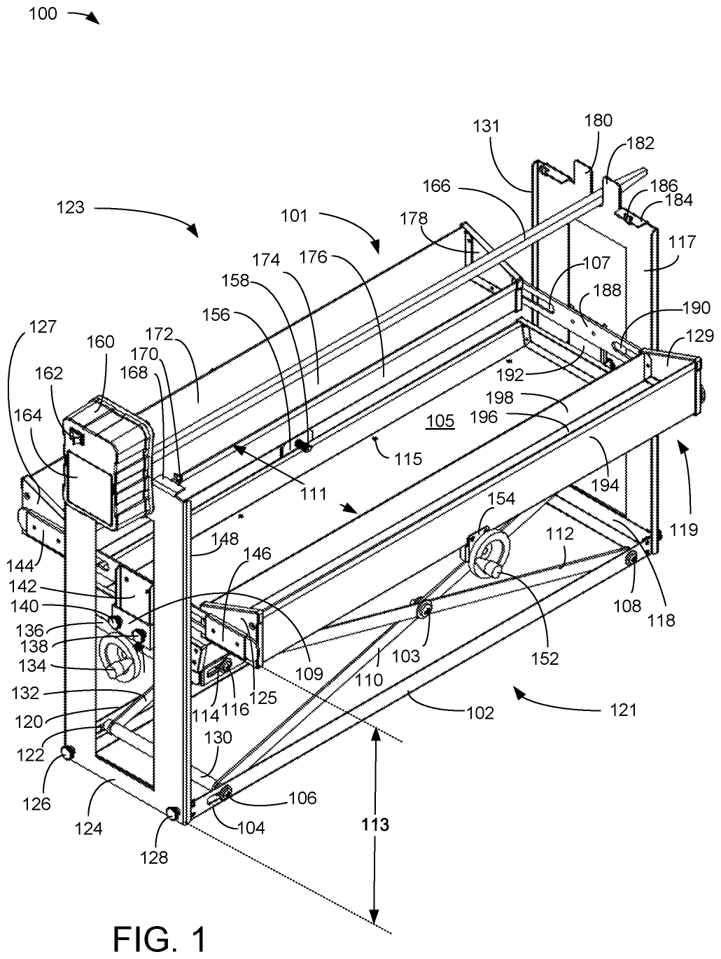

As used and defined herein, words of relative position such as “front”, “bottom”, “left”, “right”. “left-hand”, “right-hand”, etc. refer to the apparatus in the operational orientation shown in FIG. 1, where the end with the fire trays height adjustment hand crank 134 is regarded as the front, and “left” and “right” are from the perspective of a viewer facing the front. Likewise, “outer” refers to the horizontally outermost relevant extent and “inner” refers to less extent than outer. The hundred(s) digits of reference numbers refer to the drawing number in regard to which the referenced item is first shown and discussed. As used and defined herein, “barbeque cooker” means “an apparatus for cooking food using burning fuel under food”. “Angle stock” as used and defined herein refers to elongated metal parts having an L-shaped cross section, preferably of steel or iron.

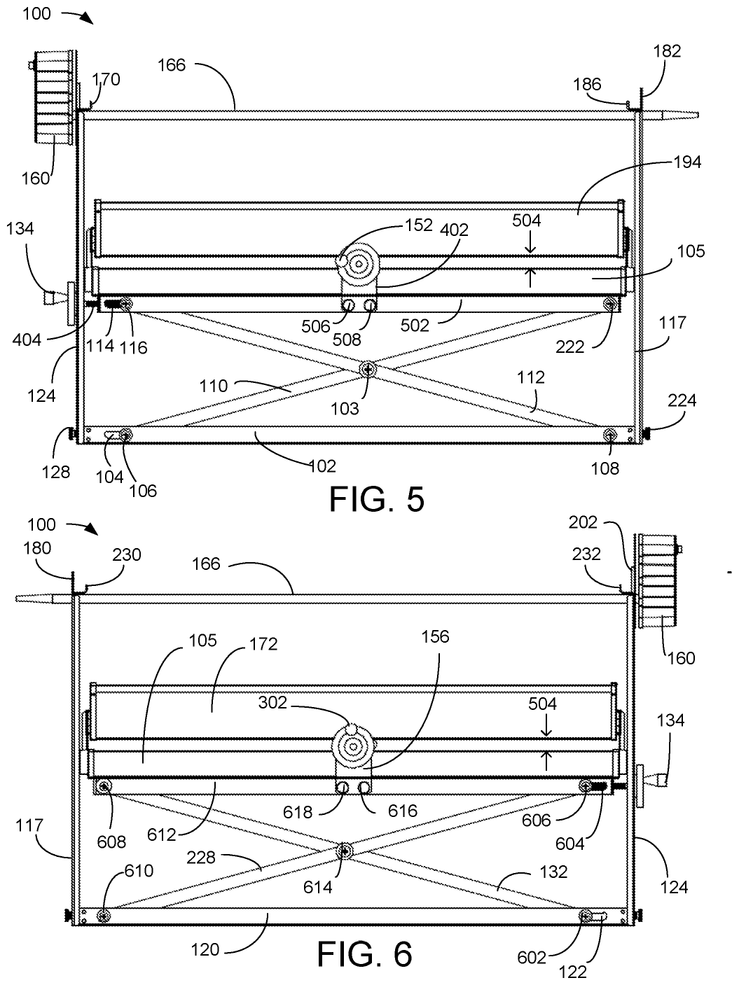

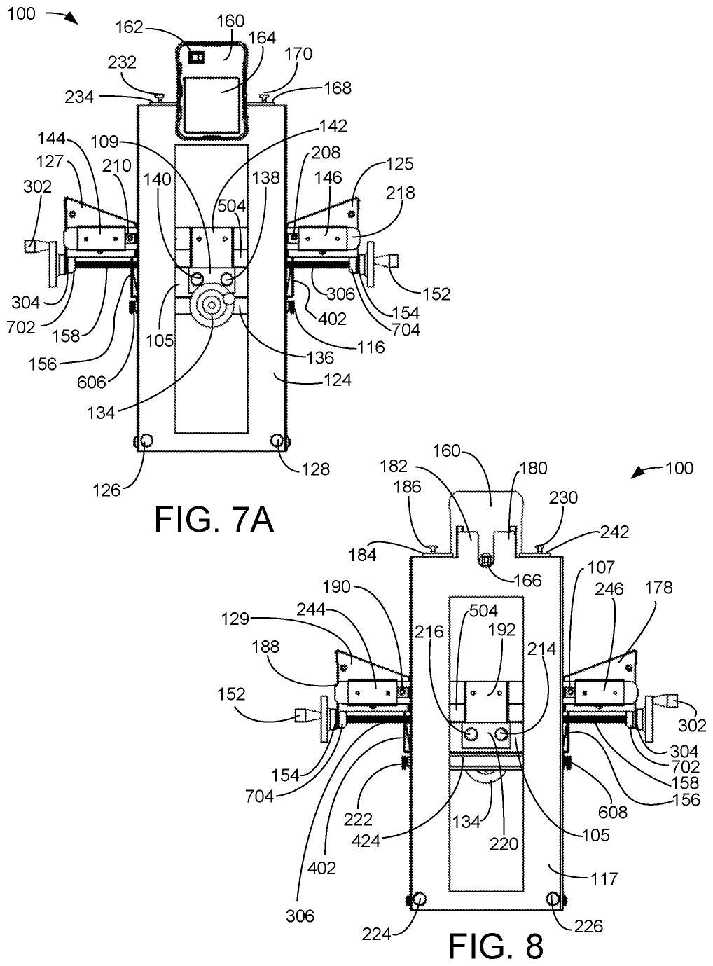

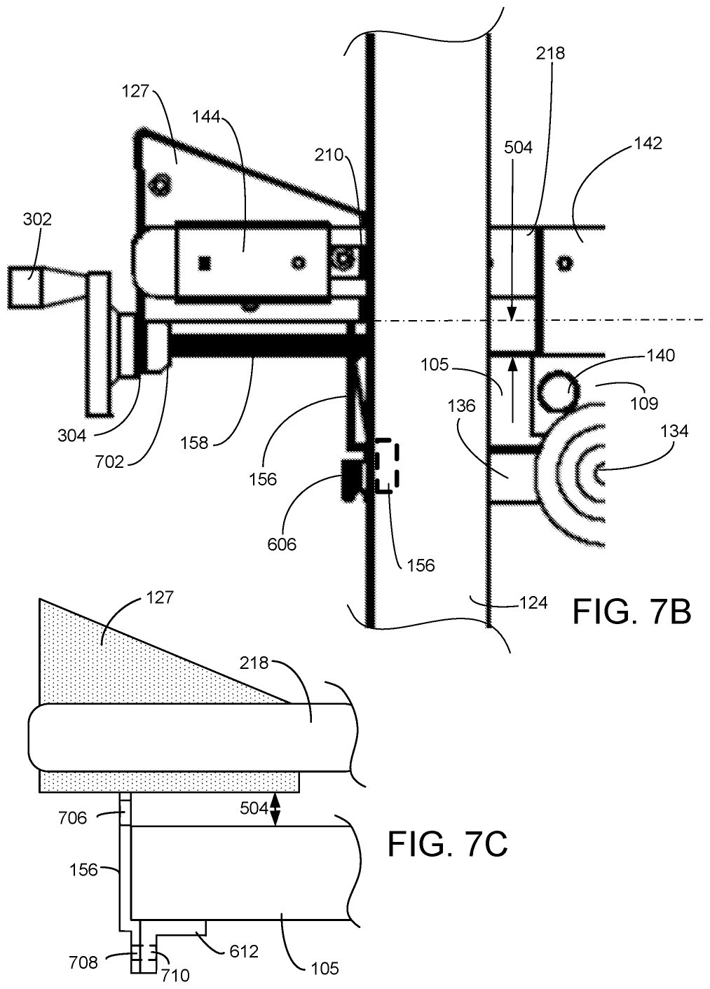

FIG. 1 is a front/side perspective view illustrating an exemplary embodiment of a barbeque cooker 100 in a first configuration, according to a preferred embodiment of the present invention. Barbeque cooker 100 includes a scissor jack assembly 121 having a drip tray 105 attached to a top of the scissor jack assembly 121. The scissor jack assembly 121 is operated by fire trays height adjustment hand crank 134 which turns scissor jack assembly screw 404 (see FIG. 4) which drives upper slot pin bar 136 via a threaded bore therein. Fire trays height adjustment hand crank 134 includes the handle, wheel, and hub, as shown in FIG. 7A. Upper slot pin bar 136 links right top long scissor jack assembly angle stock frame member 502 (see FIG. 5) with left top long scissor jack assembly angle stock frame member 612 (see FIG. 6) terminating in right top long scissor jack assembly slot pin 116 and left top long scissor jack assembly angle stock slot pin 606, respectively. Right top long scissor jack assembly slot pin 116 and left top long scissor jack assembly angle stock slot pin 606 slide in right top long scissor jack assembly angle stock slot 114 and left top long scissor jack assembly angle stock slot 604, respectively, to enable scissor jack assembly 121 to operate. Scissor jack assembly 121 is shown raised to its maximum height 113 for this illustration.

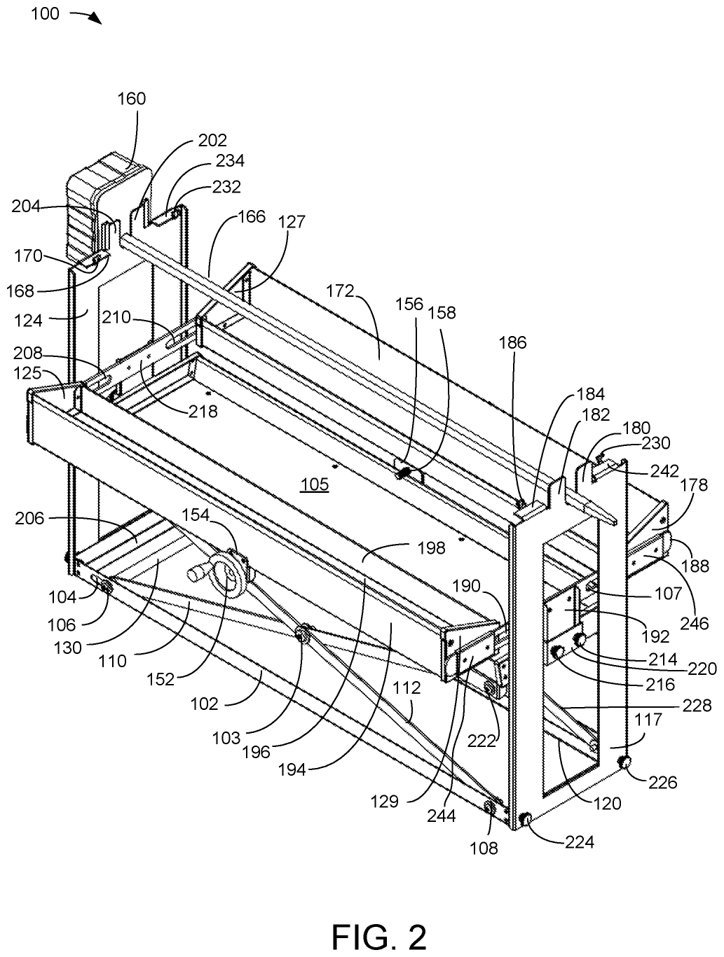

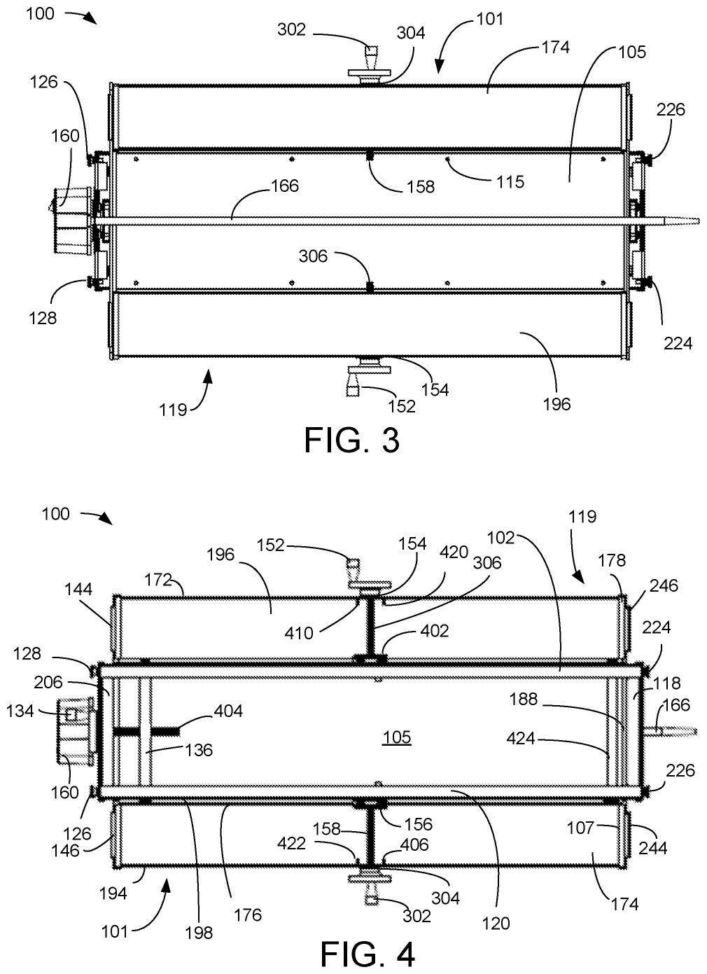

Scissor jack assembly 121 has a top frame including left top long scissor jack assembly angle stock frame member 612 (see FIG. 6), upper slot pin bar 136, and right top long scissor jack assembly angle stock frame member 502 (see FIG. 5). Left top long scissor jack assembly angle stock frame member 612 includes left top long scissor jack assembly angle stock slot 604 (see FIG. 6) slidingly receiving left top long scissor jack assembly angle stock slot pin 606 (see FIG. 6) that is attached to upper slot pin bar 136 and pivotably attached to second left side scissor jack assembly cross member 228 (see FIG. 2). Left top long scissor jack assembly angle stock frame member 612 (see FIG. 6) also includes top left rear pivot pin 608 (see FIG. 6) that is linked to first left side scissor jack assembly cross member 132. First left side scissor jack assembly cross member 132 and second left side scissor jack assembly cross member 228 (see FIG. 2) are pivotably joined by left side scissor jack assembly cross member pivot pin 614 (see FIG. 6), as shown. Left top long scissor jack assembly angle stock frame member 612 (see FIG. 6) provides two fastener openings to receive left fire tray horizontal position hand crank screw inner support bracket 156 front fastener 616 and left fire tray horizontal position hand crank screw inner support bracket 156 rear fastener 618 (see FIG. 6). The top frame of scissor jack assembly 121 includes drip tray 105 fastened to left top long scissor jack assembly angle stock frame member 612 (see FIG. 6) and to right top long scissor jack assembly angle stock frame member 502 (see FIG. 5) via fasteners 115 (one of three visible; also see FIG. 3, one of eight labeled).

As shown, right top long scissor jack assembly slot pin 116 is at an end of right top long scissor jack assembly angle stock slot 114, indicating the maximum height 113 for scissor jack assembly 121.

Scissor jack assembly 121 has a bottom frame including right bottom long scissor jack assembly angle stock frame member 102, rear bottom angle stock scissor jack assembly frame member 118, left bottom long scissor jack assembly angle stock frame member 120, and front bottom angle stock scissor jack assembly frame member 206 (see FIG. 2). Right bottom long scissor jack assembly angle stock frame member 102 has right bottom long scissor jack assembly angle stock slot 104 slidingly receiving right bottom long scissor jack assembly slot pin 106, which is coupled to lower slot pin bar 130 which is pivotably connected to first right side scissor jack assembly cross member 110, as shown. Right bottom long scissor jack assembly angle stock frame member 102 supports right bottom long scissor jack assembly angle stock pivot pin 108 which is pivotably connected to a lower end of second right side scissor jack assembly cross member 112. Second right side scissor jack assembly cross member 112 and first right side scissor jack assembly cross member 110 are pivotably joined at their centers by right side scissor jack assembly cross member pivot pin 103.

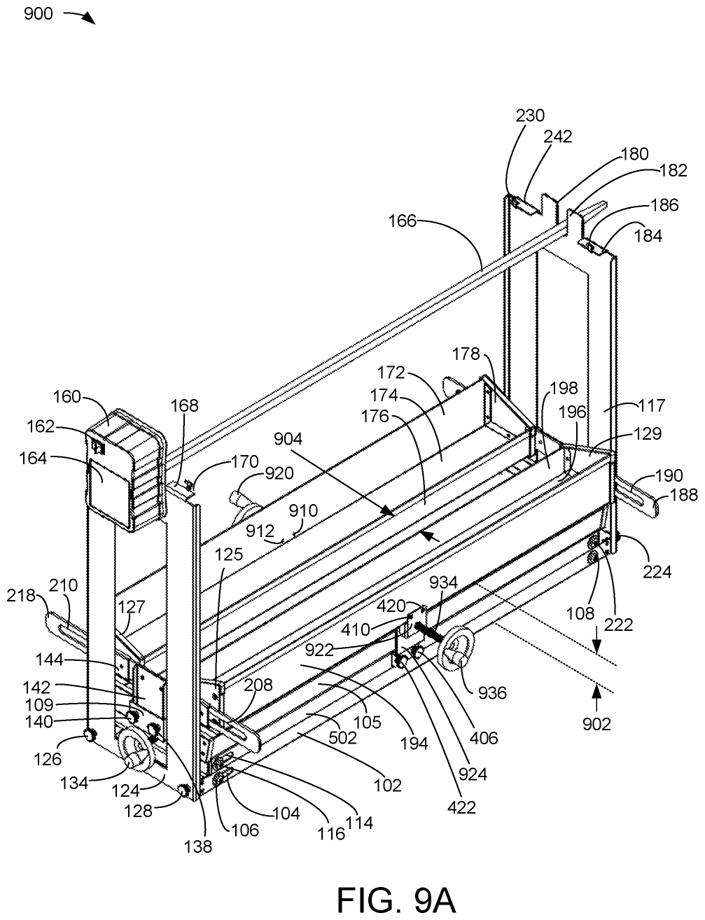

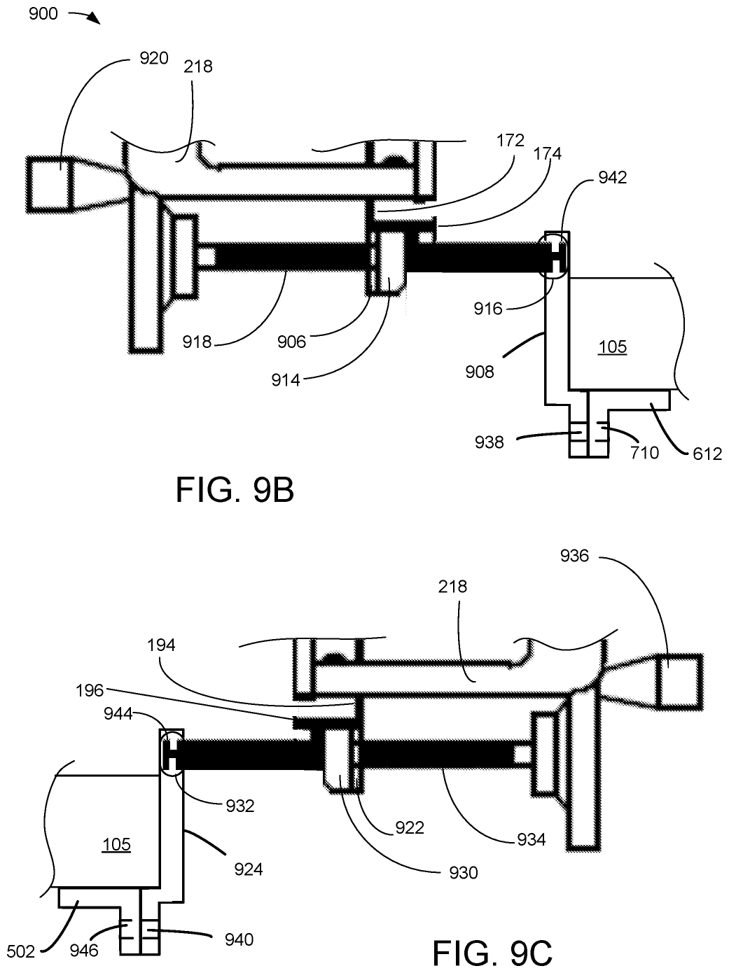

Fire tray assembly 123 includes left fire tray 101, right fire tray 119, and front and rear fire tray support members 218 (see FIG. 2) and 188, respectfully. Fire trays 101 and 119 hold burning charcoal, wood chips, cans of ethanol gel, and/or other fuels for barbeque cooking. Right fire tray 119 includes right fire tray floor 196, right fire tray inner wall 198, right fire tray outer wall 194, right fire tray rear wall 129, and right fire tray front wall 125, as shown. Right fire tray outer wall 194 has two openings (similar to 910 and 912 in FIG. 9A) to receive right fire tray horizontal position hand crank screw outer support bracket 154 front fastener 410 and right fire tray horizontal position hand crank screw outer support bracket 154 rear fastener 420 for attaching right fire tray hand crank outer support bracket 154 that supports right fire tray horizontal position hand crank 152 and right fire tray horizontal position hand crank screw 306.

Left fire tray 101 includes left fire tray floor 174, left fire tray inner wall 176, left fire tray outer wall 172, left fire tray front wall 127, and left fire tray rear wall 178. Left fire tray outer wall 172 has two openings: left fire tray rear hand crank outer support bracket rear fastener receiver 910 (see FIG. 9) and left fire tray rear hand crank outer support bracket front fastener receiver 912 (see FIG. 9) for receiving left fire tray horizontal position hand crank screw outer bracket rear fastener 406 and left fire tray horizontal position hand crank screw outer bracket front fastener 422, respectively, which is for attaching left fire tray hand crank outer support bracket 304 (see FIG. 3).

Rear fire tray support member 188 attaches to drip tray 105 via rear fire tray assembly pillar 192 and is fastened, via left rear fire tray assembly fastener 214 (see FIG. 2) and right rear fire tray assembly fastener 216 (see FIG. 2), between drip tray 105 and rear fire tray receiver 220 (see FIG. 2). Rear fire tray support member 188 has right rear fire tray slider slot 190 and left rear fire tray slider slot 107. Right rear fire tray slider sleeve 244 (see FIG. 2) is bent to partially wrap around a right-hand portion of rear fire tray support member 188 and extends two pins through right rear fire tray right rear fire tray slider slot 190 to fasten to the right fire tray rear wall 129. When driven by right fire tray horizontal position hand crank 152, right fire tray 119 moves horizontally, aligned with the right rear fire tray slot 190, without tipping. Left rear fire tray slider sleeve 246 (see FIG. 2) is bent to partially wrap around a left-hand portion of rear fire tray support member 188 and extends two pins through left rear fire tray slider slot 107 to fasten to the left fire tray rear wall 178. When driven by left fire tray horizontal position hand crank 303 (see FIG. 3), left fire tray 101 moves horizontally, aligned with the left rear fire tray slider slot 107, without tipping.

Front fire tray support member 218 (see FIG. 2) attaches to drip tray 105 via front fire tray assembly pillar 142 and is fastened, via left front fire tray assembly fastener 140 and right front fire tray assembly fastener 138, between drip tray 105 and front fire tray receiver 109. The dimensions of the front fire tray assembly pillar 142 and the rear fire tray assembly pillar 192 create a vertical space 504 (see FIG. 5) between the top of drip tray 105 and the bottoms of fire trays 101 and 119 through which the left fire tray horizontal position hand crank screw 158 and the right fire tray horizontal position hand crank screw 306 (see FIG. 3) may extend. Front fire tray support member 218 (see FIG. 2) has a front right fire tray slider slot 208 and a front left fire tray slider slot 210 (see FIG. 2), as shown. Right front fire tray slider sleeve 146 is bent to partially wrap around a right-hand portion of front fire tray support member 218 (see FIG. 2) and extends two pins through right front fire tray slider slot 208 (see FIG. 2) to fasten to the right fire tray front wall 125. When driven by right fire tray horizontal position hand crank 152, right fire tray 119 moves horizontally, aligned with the right front fire tray slider slot 208, without tipping. Left front fire tray slider sleeve 144 is bent to partially wrap around a right-hand portion of front fire tray support member 218 (see FIG. 2) and extends two pins through left front fire tray slider slot 210 (see FIG. 2) to fasten to the left fire tray front wall 127. When driven by left fire tray horizontal position hand crank 302 (see FIG. 3), left fire tray 101 moves horizontally, aligned with the left front fire tray slider slot 210 (see FIG. 2), without tipping. In FIG. 1, the fire trays 101 and 119 are shown at a maximum fire tray separation distance 111 apart. Because each fire tray 101 and 119 can be independently positioned, many variations in positions are possible and symmetry of position is not required.

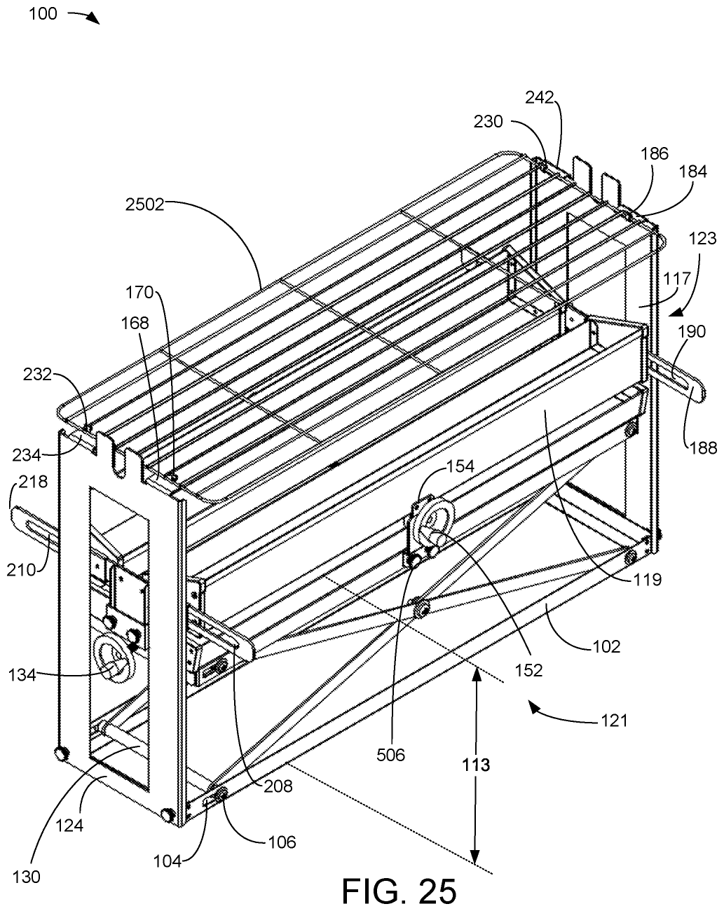

Front end frame 124 is attached to right bottom long scissor jack assembly angle stock frame member 102 and left bottom long scissor jack assembly angle stock frame member 120 via front right frame fastener 128 and front left frame fastener 126, respectively, as shown. Front end frame 124 includes front right grill support 168 having a front right gill retainer 170 extending upwardly from the front right grill support 168. In operation, a grill 2502 (see FIG. 25) is supported on front right grill support 168 and front right gill retainer 170 prevents horizontal or vertical movement of the grill 2502 (see FIG. 25). Front end frame 124 includes vertical front end side flanges 148 (one visible in this view). Rear end frame 117 includes vertical side flanges 131 (one of two labeled), as shown. In a particular embodiment, front right gill retainer 170 may be a bolt, extending upward from front right grill support 168, with a wing nut. Front end frame 124 includes front left grill support flange 234 (see FIG. 2) having a left front gill retainer 232 (see FIG. 2) extending upwardly from the front left grill support flange 234 (see FIG. 2). Front end frame 124 also includes front left rotisserie retainer 202 (see FIG. 2) and front right rotisserie retainer 204 (see FIG. 2) for supporting a rotisserie 160 and defining a notch there between for holding rotisserie food support bar 166. A small portion of the right side of drip tray 105 can be seen in this view.

Rear end frame 117 is attached to rear ends of right bottom long scissor jack assembly angle stock frame member 102 and left bottom long scissor jack assembly angle stock frame member 120 by right rear frame fastener 224 (see FIG. 2) and left rear frame fastener 226 (see FIG. 2), respectively. Rear end frame 117 includes rear right grill support flange 184 and rear right grill retainer 186 as well as left rear grill support flange 242 (see FIG. 2) and left rear grill retainer 230 (see FIG. 2). Rear end frame 117 also includes rear left rotisserie bar retainer 180 and rear right rotisserie bar retainer 182. Front end frame 124 and rear end frame 117 are mirror images of each other and either can support a rotisserie 160. Rotisserie 160 preferably has motor, a power switch 162, and rotisserie motor controls 164 for setting rotation speed, timers, etc.

FIG. 2 is a rear/side perspective view illustrating the exemplary embodiment of the barbeque cooker 100 in a first configuration of FIG. 1, according to a preferred embodiment of the present invention. Second left side scissor jack assembly cross member 228 is first shown in this view. Rear fire tray receiver 220 receives rear fire tray assembly pillar 192 and fastens it in place with left rear fire tray assembly fastener 214 and right rear fire tray assembly fastener 216. Rear fire tray assembly pillar 192 is fixed to rear fire tray support member 188. Front fire tray support member 218 is shown with front right fire tray slider slot 208 and front left fire tray slider slot 210. Front end frame 124 includes front left rotisserie retainer 202, front right rotisserie retainer 204, left front grill support flange 234, and left front grill retainer 232. The four grill supports 168, 184, 234, and 242 support grill 2502 (see FIG. 25) and four grill retainers 170, 186, 230, and 232, respectively, restrict horizontal movement of the grill 2502. Front bottom angle stock scissor jack assembly frame member 206 extends between right bottom long scissor jack assembly angle stock frame member 102 and left bottom long scissor jack assembly angle stock frame member 120.

Rear end frame 117 is fastened to rear ends of right bottom long scissor jack assembly angle stock frame member 102 and left bottom long scissor jack assembly angle stock frame member 120 using right rear frame fastener 224 and left rear frame fastener 226, respectively. Top right rear scissor pivot 222 can be seen at the junction of first right side scissor jack assembly cross member 110 and right top long scissor jack assembly angle stock frame member 502 (see FIG. 5). Right rear fire tray slider sleeve 244 and left rear fire tray slider sleeve 246 are shown at positions of maximum extension on rear fire tray support member 188.

FIG. 3 is a top plan view illustrating the exemplary embodiment of the barbeque cooker 100 of FIG. 1, according to a preferred embodiment of the present invention. Left fire tray horizontal position hand crank 302 is shown aligned with left fire tray hand crank outer support bracket 304. Portions of left fire tray horizontal position hand crank screw 158 and right fire tray horizontal position hand crank screw 306 can be seen protruding through vertical space 504 (see FIG. 5) between the top of drip tray 105 and the bottoms of fire trays 101 and 119, respectively. Right fire tray hand crank outer support bracket 154 supports right fire tray horizontal position hand crank 152. Right fire tray horizontal position hand crank screw 306 is shown protruding above drip tray 105 and below right fire tray 119. Left fire tray horizontal position hand crank screw 158 is shown protruding below left fire tray 101 and above drip tray 105. All eight fasteners 115 (one of eight labeled) are also shown in FIG. 3.

FIG. 4 is a bottom plan view illustrating the exemplary embodiment of the barbeque cooker 100 of FIG. 1, according to a preferred embodiment of the present invention. Scissor jack assembly screw 404 is shown extending from fire trays height adjustment hand crank 134, below drip tray 105, and through a threaded opening in upper slot pin bar 136 (lower slot pin bar 130 omitted in this view). Scissor jack assembly 121 is operated by manually rotating fire trays height adjustment hand crank 134 to draw upper slot pin bar 136 nearer, or to drive upper slot pin bar 136 further from, fire trays height adjustment hand crank 134. Rear scissor jack assembly pivot pin bar 424 holds top right rear scissor pivot pin 222 and top left rear scissors pivot pin 608 (see FIG. 6). Top right rear scissor pivot 222 enables first right-side scissor jack assembly cross member 110 to pivot relative to right top long scissor jack assembly angle stock frame member 502 (see FIG. 5). Top left rear scissors pivot pin 608 (see FIG. 6) enables first left side scissor jack assembly cross member 132 to pivot relative to left top long scissor jack assembly angle stock frame member 612 (see FIG. 6). Right horizontal position hand crank inner screw bracket 402 attaches to right top long scissor jack assembly angle stock frame member 502 (see FIG. 5) and provides a threaded receiver for right fire tray horizontal position hand crank screw 306. Right fire tray hand crank support bracket 154 attaches to left fire tray outer wall 172 via right fire tray horizontal position hand crank screw outer bracket front fastener 410 and right fire tray horizontal position hand crank screw outer bracket 154 rear fastener 420. Right fire tray hand crank screw outer support bracket 154 provides a non-threaded receiver for right fire tray horizontal position hand crank screw 306 and, therefore, right fire tray horizontal position hand crank 152.

Left horizontal position hand crank screw inner support bracket 156 attaches to left top long scissor jack assembly angle stock frame member 612 (see FIG. 6) via left fire tray hand crank inner support bracket rear fastener 618 (see FIG. 6) and left fire tray hand crank inner support bracket front fastener 616 (see FIG. 6). Left fire tray hand crank outer support bracket 304 attaches to left fire tray outer wall 194 via left fire tray horizontal position hand crank screw bracket front fastener 422 and left fire tray horizontal position hand crank screw bracket rear fastener 406. Left fire tray hand crank outer support bracket 304 provides a non-threaded receiver for left fire tray horizontal position hand crank screw 158 and, therefore, left fire tray horizontal position hand crank 302.

FIG. 5 is a right-side elevation view illustrating the exemplary embodiment of the barbeque cooker 100 of FIG. 1, according to a preferred embodiment of the present invention. The attachment of right horizontal position hand crank screw inner support bracket 402 to right top long scissor jack assembly angle stock frame member 502 via right fire tray hand crank inner support bracket front fastener 506 and right fire tray hand crank inner support bracket rear fastener 508 can be best seen in this view. Vertical space 504 between the top of drip tray 105 and the bottom of fire trays 101 and 119 is sized to allow left fire tray horizontal position hand crank screw 158 and right fire tray horizontal position hand crank screw 306 to protrude through vertical space 504. The right side of drip tray 105 is shown in this view.

FIG. 6 is a left side elevation view illustrating the exemplary embodiment of the barbeque cooker 100 of FIG. 1, according to a preferred embodiment of the present invention. The attachment of left horizontal position hand crank screw inner support bracket 156 to left top long scissor jack assembly angle stock frame member 612 via left fire tray hand crank inner support bracket front fastener 616 and left fire tray hand crank inner support bracket rear fastener 618 can be best seen in this view. Left top long scissor jack assembly angle stock frame member 612 is pivotally connected to first left side scissor jack assembly cross member 132 by top left rear scissors pivot pin 608 and to second left side scissor jack assembly cross member 228 via left top long scissor jack assembly angle stock slot pin 606 which is slidingly engaged in left top long scissor jack assembly angle stock slot 604. Left bottom long scissor jack assembly angle stock frame member 120 is pivotally attached to second left side scissor jack assembly cross member 228 by bottom left rear pivot pin 610 and to first left side scissor jack assembly cross member 132 by left bottom long scissor jack assembly angle stock slot pin 602, which is slidingly engaged in left bottom long scissor jack assembly angle stock slot 122. Second left side scissor jack assembly cross member 228 first left side scissor jack assembly cross member 132 are pivotally connected by left side scissor jack assembly cross member pivot pin 614. The left side of drip tray 105 is shown in this view.

FIG. 7A is a front elevation view illustrating the exemplary embodiment of the barbeque cooker 100 of FIG. 1, according to a preferred embodiment of the present invention. Left fire tray hand crank outer support bracket 304 supports left fire tray horizontal position hand crank 302, left fire tray horizontal position hand crank bearing 702, and left fire tray horizontal position hand crank screw 158. Left fire tray horizontal position hand crank 302 is attached to left fire tray horizontal position hand crank screw 158. Left fire tray horizontal position hand crank bearing 702 is attached to left fire tray hand crank outer support bracket 304. Left fire tray hand crank outer support bracket 304 and left fire tray horizontal position hand crank bearing 702 do not engage the threads of left fire tray horizontal position hand crank screw 158. Left horizontal position hand crank screw inner support bracket 156 is attached to left top long scissor jack assembly angle stock frame member 612 and engages the threads of left fire tray horizontal position hand crank screw 158. The front side of drip tray 105 can be seen in this view.

Right fire tray hand crank screw outer support bracket 154 supports right fire tray horizontal position hand crank 152, right fire tray horizontal position hand crank bearing 704, and right fire tray horizontal position hand crank screw 306. Right fire tray horizontal position hand crank 152 is attached to right fire tray horizontal position hand crank screw 306. Right fire tray hand crank screw outer support bracket 154 and right fire tray horizontal position hand crank bearing 704 do not engage the threads of right fire tray horizontal position hand crank screw 306.

FIG. 7B is a front elevation detail of FIG. 7 view illustrating the exemplary embodiment of the barbeque cooker 100 of FIG. 1, according to a preferred embodiment of the present invention. A hidden portion of left horizontal position hand crank screw inner support bracket 156 is shown in dotted lines. The vertical space 504 between the top of drip tray 105 and the bottom of fire trays 101 and 119 is shown concisely. The rear side of drip tray 105 can be seen in this view.

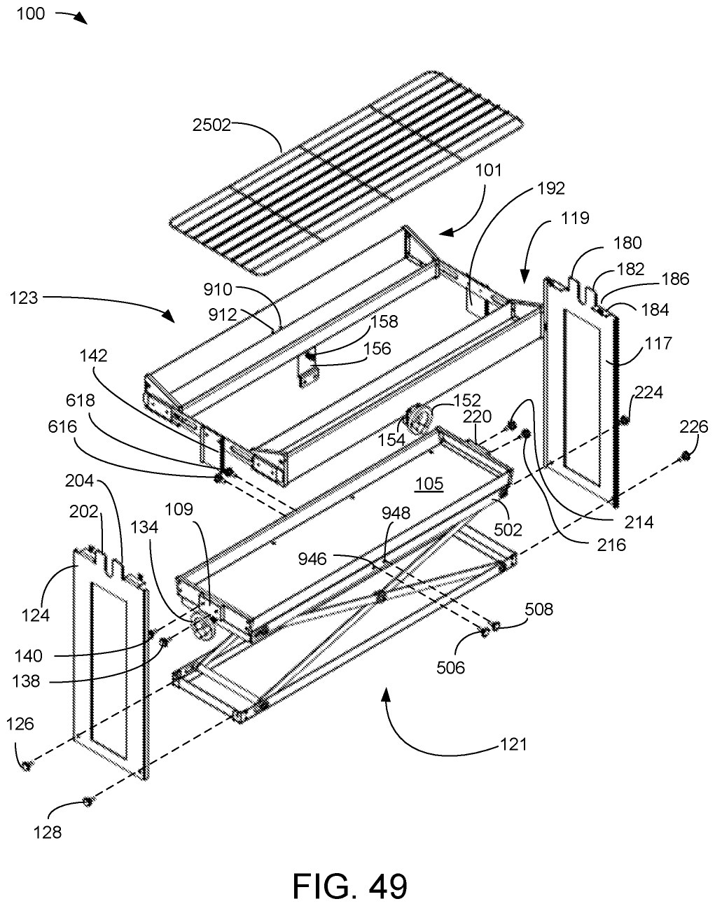

FIG. 7C is a diagrammatic view illustrating a side view of the left horizontal position hand crank screw inner support bracket 156 of the exemplary embodiment of the barbeque cooker 100 of FIG. 1, according to a preferred embodiment of the present invention. The left horizontal position hand crank screw inner support bracket 156 includes left fire tray horizontal position hand crank screw 158 threaded receiver 706 and left horizontal position hand crank inner screw bracket fastener receiver 708 for left fire tray hand crank inner support bracket front fastener 616. Left horizontal position hand crank screw inner bracket fastener receiver 708 aligns, during assembly, with fastener receiver 710, similar to fastener receiver 4914 (see FIG. 49) in right top long scissor jack assembly angle stock frame member 502. See also the left horizontal position hand crank screw inner support bracket 156 in FIG. 49.

FIG. 8 is a rear elevation view illustrating the exemplary embodiment of the barbeque cooker 100 of FIG. 1, according to a preferred embodiment of the present invention. This view is shown for completeness and contains no new parts.

FIG. 9A is a front/side perspective view illustrating a second exemplary embodiment of the barbeque cooker 900 in a second configuration, according to a preferred embodiment of the present invention. Fire tray assembly 123 is configured at an adjusted fire tray minimum height 902 and fire tray minimum horizontal spacing 904. The extremes in positions in horizontal and vertical fire tray positions (111 vs 904; and 113 vs 902) are not a limitation of the present invention. For example, any intermediate positions between fire tray maximum separation distance 111 and fire tray minimum horizontal spacing 904 may be used. Likewise, any intermediate height between adjusted fire tray maximum height 113 and adjusted fire tray minimum height 902 is within the scope of the present invention. In addition, the positions of left fire tray 101 and right fire tray 119 need not be symmetrical, as their positions are independently controlled by right fire tray horizontal position hand crank 936 and left fire tray horizontal position horizontal position hand crank 920, respectively.

Unlike the first embodiment of the barbeque cooker 100, right fire tray hand crank outer support bracket 922 attaches to threaded right fire tray horizontal position hand crank nut 930 (see FIG. 9C), similar to right fire tray horizontal position hand crank bearing 704, but threaded. Likewise, left fire tray hand crank inner support bracket 906 is not threaded, but captures the distal end of left fire tray horizontal position hand crank screw 918 in left unthreaded screw retainer bearing 916 in a circumferential groove in the end of the left fire tray horizontal position hand crank screw 918.

FIG. 9B is a side elevation detail view illustrating the second exemplary embodiment of the barbeque cooker 900 of FIG. 9A in a second configuration, according to a preferred embodiment of the present invention. In FIGS. 9B and 9C, the left fire tray 101 and the right fire tray 119 are not yet positioned to the fire tray minimum horizontal spacing 904. Left fire tray hand crank outer support bracket 906 is attached to right fire tray outer wall 172 and supports threaded left fire tray horizontal position hand crank nut 914. In some embodiments, threaded left fire tray horizontal position hand crank nut 914 is also secured to the underside of the left fire tray floor 174. Left fire tray hand crank inner support bracket 908 supports left unthreaded screw retainer bearing 916 which retains the distal end 942 of the left fire tray horizontal position hand crank screw 918. By operation of left fire tray horizontal position hand crank 920, left fire tray horizontal position hand crank screw 918 rotates freely in left unthreaded screw retainer bearing 916 and engages threads in threaded left fire tray horizontal position hand crank nut 914 to drive left fire tray 101 toward or away from left fire tray hand crank inner support bracket 908. Left fire tray hand crank inner support bracket 908 fastens to left top long scissor jack assembly angle stock frame member 612 via aligned left horizontal position hand crank inner screw bracket fastener receiver 938 and fastener receiver 710.

FIG. 9C is a side elevation detail view illustrating the second exemplary embodiment of the barbeque cooker 900 of FIG. 9A in a second configuration, according to a preferred embodiment of the present invention. In FIGS. 9B and 9C, the left fire tray 101 and the right fire tray 119 are not yet positioned to the fire tray minimum horizontal spacing 904. Right fire tray hand crank outer support bracket 922 is attached to right fire tray outer wall 194 and supports threaded right fire tray horizontal position hand crank nut 930. In some embodiments, threaded right fire tray horizontal position hand crank nut 930 is also secured to the underside of the right fire tray floor 196. Right fire tray hand crank inner support bracket 924 supports right unthreaded screw retainer bearing 932 which retains the distal end 944 of the right fire tray horizontal position hand crank screw 934. By operation of the right fire tray horizontal position hand crank 936, right fire tray horizontal position hand crank screw 934 rotates freely in right unthreaded screw retainer bearing 932 and engages threads in threaded right fire tray horizontal position hand crank nut 930 to drive right fire tray 119 toward or away from right fire tray hand crank inner support bracket 924. Right fire tray hand crank inner support bracket 924 fastens to right top long scissor jack assembly angle stock frame member 502 via aligned right horizontal position hand crank inner screw bracket fastener receiver 940 and right fire tray inner hand crank support front fastener receiver 946, as well as by right fire tray inner hand crank support rear fastener receiver 948 (see FIG. 49) though an opening (not shown) in right fire tray hand crank inner support bracket 924 receiving fastener 406.

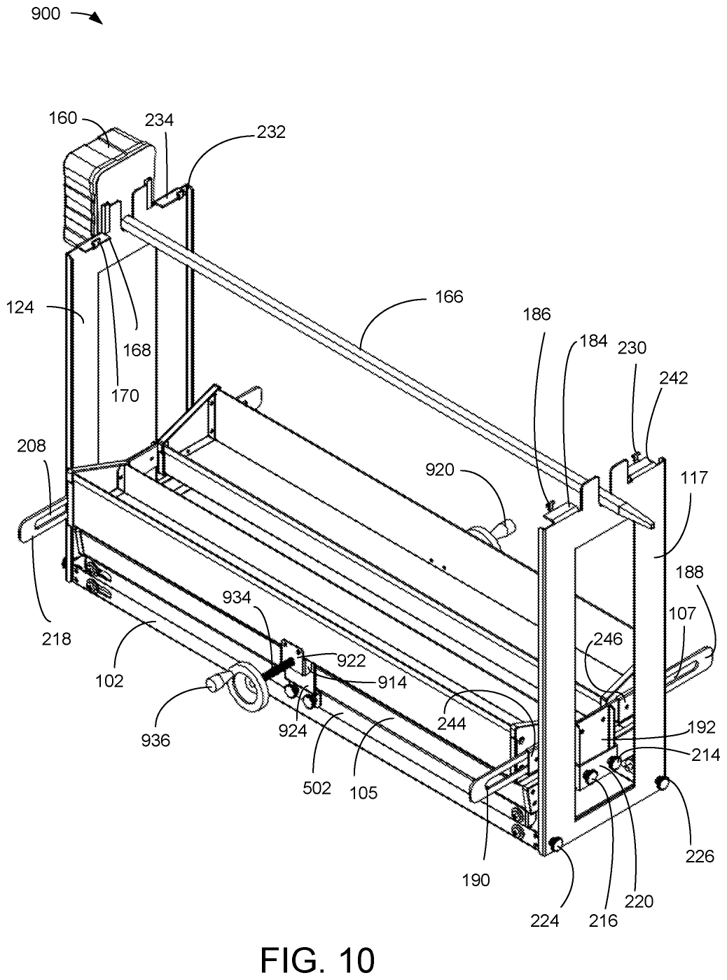

FIG. 10 is a rear/side perspective view illustrating an exemplary embodiment of the barbeque cooker 900 of FIG. 9A in the second configuration, according to a preferred embodiment of the present invention. FIG. 10 is provided to complete perspective. No new parts are shown.

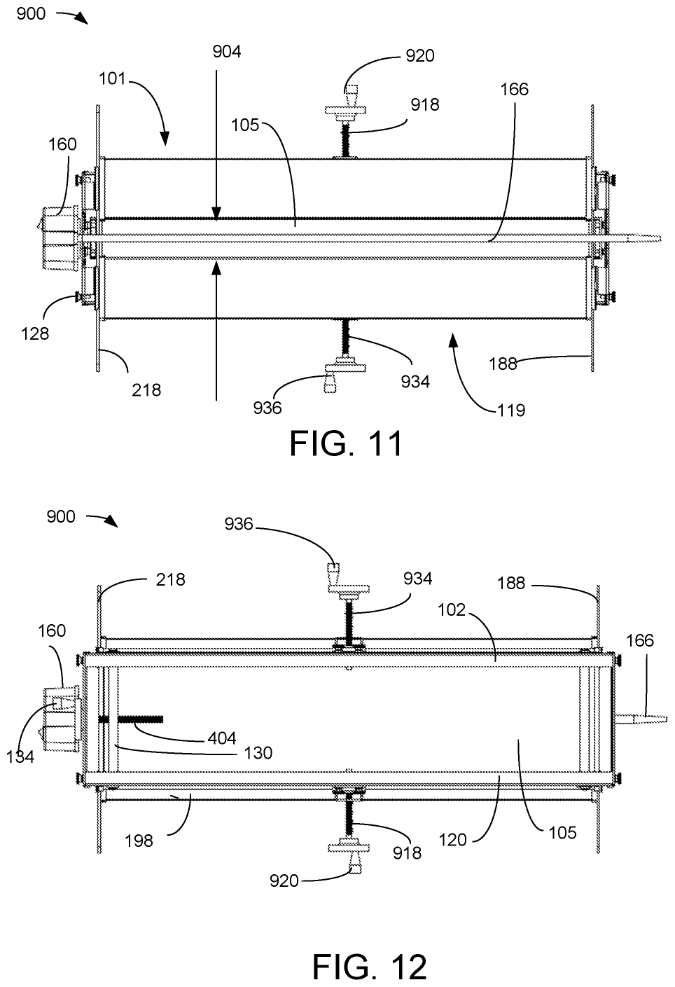

FIG. 11 is a top plan view illustrating the second exemplary embodiment of the barbeque cooker 900 of FIG. 9A in the second configuration, according to a preferred embodiment of the present invention. The fire tray minimum horizontal spacing 904 leaves access to the drip tray 105. The fire trays 101 and 119 are symmetrically aligned relative to the rotisserie food support bar 166, but this is not a limitation of the present invention: fire trays 101 and 119 may be arranged asymmetrically, if the user so desires.

FIG. 12 is a bottom plan view illustrating the second exemplary embodiment of the barbeque cooker 900 of FIG. 9A in the second configuration, according to a preferred embodiment of the present invention. Lower slot pin bar 130 is shown in its proper position, blocking the view of upper slot pin bar 136.

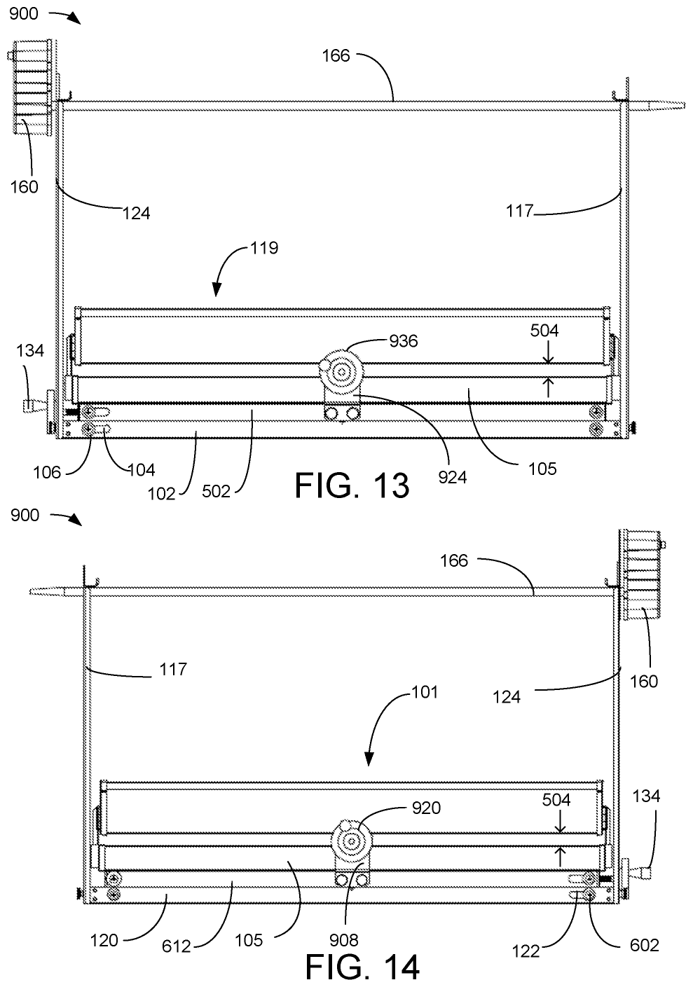

FIG. 13 is a right-side elevation view illustrating the second exemplary embodiment of the barbeque cooker 900 of FIG. 9A in the second configuration, according to a preferred embodiment of the present invention. Even when right fire tray 119 is in its lowest vertical position, as shown, vertical space 504 remains constant.

FIG. 14 is a left side elevation view illustrating the second exemplary embodiment of the barbeque cooker 900 of FIG. 9A in the second configuration, according to a preferred embodiment of the present invention. Rotisserie food support bar 166 is capable of supporting various attachments, as are known in the art, for providing additional support for the food on the rotisserie. Right fire tray horizontal position hand crank 936 and left fire tray horizontal position hand crank 920 operate independently, allowing asymmetrical positioning of the fire trays 119 and 101, respectively.

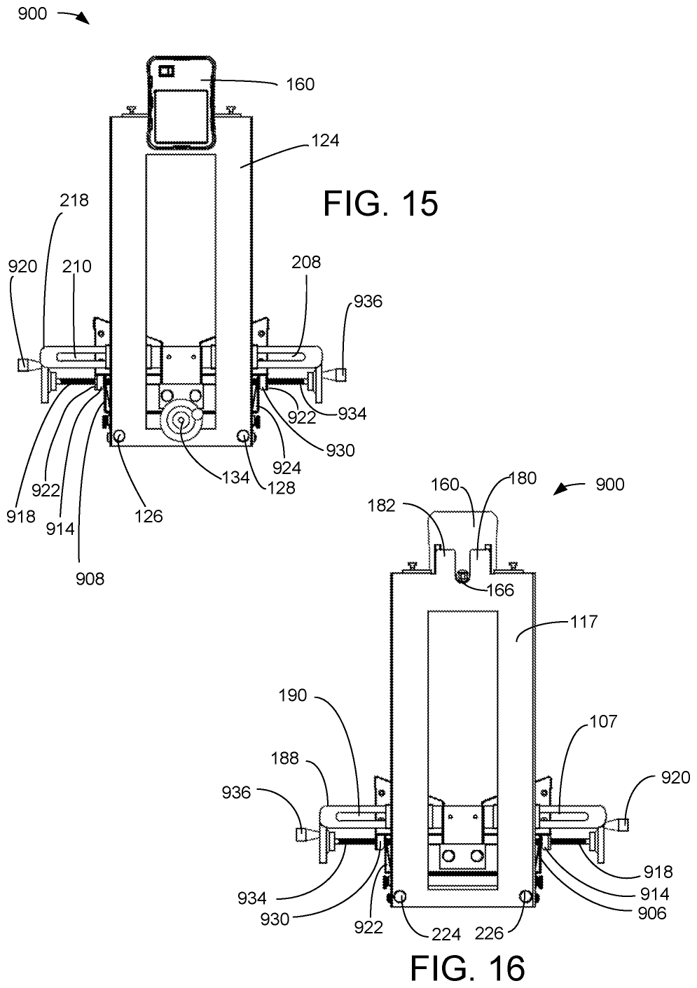

FIG. 15 is a front elevation view illustrating the second exemplary embodiment of the barbeque cooker 900 of FIG. 9A in the second configuration, according to a preferred embodiment of the present invention. Front fire tray support member 218 includes front right fire tray slider slot 208 and front left fire tray slider slot 210.

FIG. 16 is a rear elevation view illustrating the second exemplary embodiment of the barbeque cooker 900 of FIG. 9A in the second configuration, according to a preferred embodiment of the present invention. Rear fire tray support member 188 includes right rear fire tray slider slot 190 and left rear fire tray slider slot 107. The horizontal adjustment screw assemblies of barbeque cooker 900 may be used with any of the configurations of embodiment 100 and also intermediate configurations not illustrated.

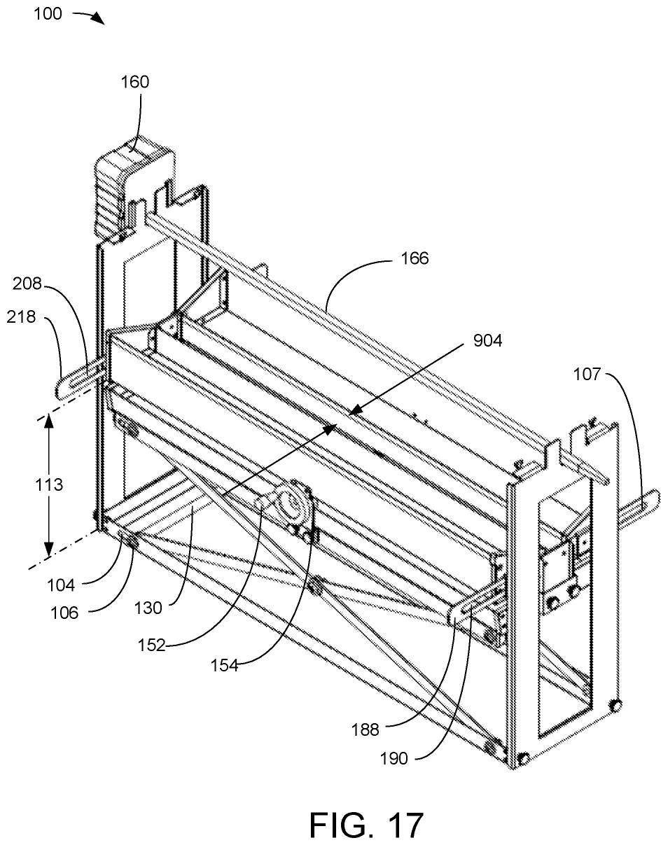

FIG. 17 is a front/side perspective view illustrating the exemplary first embodiment of the barbeque cooker 100 of FIG. 1 in a third configuration, according to a preferred embodiment of the present invention. This embodiment is configured with fire tray minimum horizontal spacing 904 and adjusted fire tray maximum height 113. The third configuration provides the most heat to food on the rotisserie food support bar 166. Right bottom long scissor jack assembly slot pin 106 is shown at the rear end of right bottom long scissor jack assembly angle stock slot 104, confirming adjusted fire tray maximum height 113.

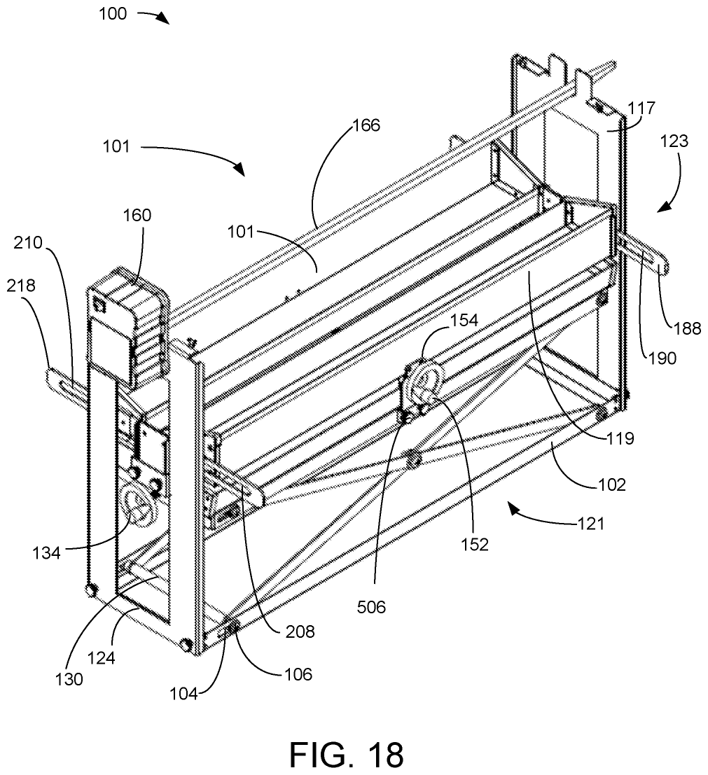

FIG. 18 is a rear/side perspective view illustrating the exemplary first embodiment of the barbeque cooker 100 of FIG. 1 in the third configuration, according to a preferred embodiment of the present invention. Fire tray assembly 123 includes left fire tray 101, right fire tray 119, and front and rear fire tray support members 218 and 188, respectfully.

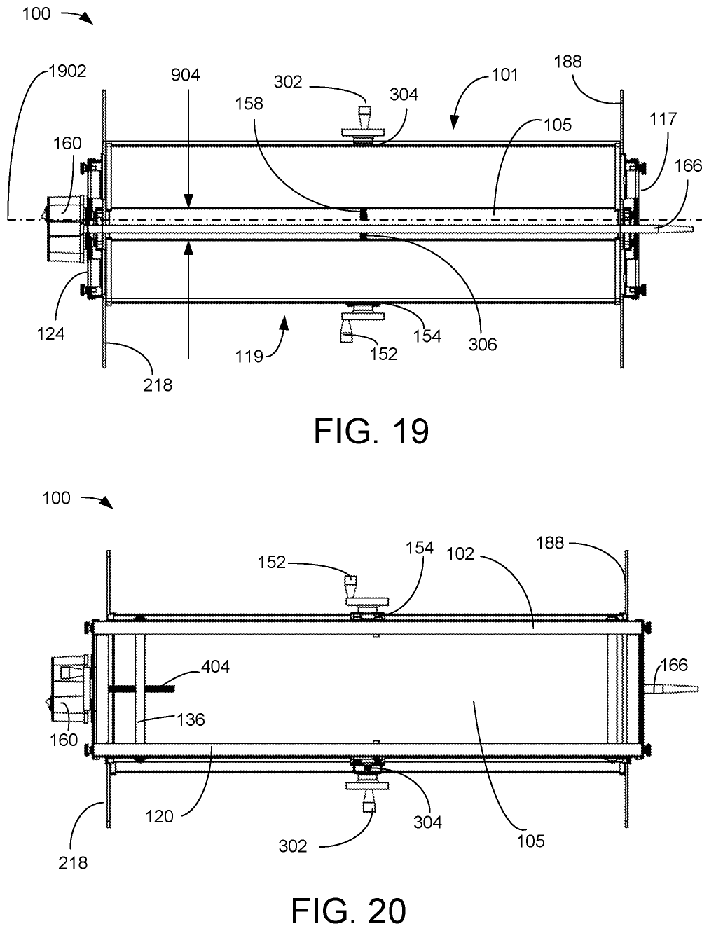

FIG. 19 is a top plan view illustrating the exemplary first embodiment of the barbeque cooker 100 of FIG. 1 in the third configuration, according to a preferred embodiment of the present invention. The centerline 1902 of fire tray assembly 123 is not aligned to the rotisserie food support bar 166, illustrating a simple asymmetrical fire tray assembly 123 configuration.

FIG. 20 is a bottom plan view illustrating the exemplary first embodiment of the barbeque cooker 100 of FIG. 1 in the third configuration, according to a preferred embodiment of the present invention. Drip tray 105 includes the horizontal bottom, as shown, as well as the upright sides and ends. Note that scissor jack assembly screw 404 has sufficient length to raise the scissor jack assembly 121 higher, but for the limitations imposed by the lengths of right bottom long scissor jack assembly angle stock slot 104, right top long scissor jack assembly angle stock slot 114, left bottom long scissor jack assembly angle stock slot 122, and left top long scissor jack assembly angle stock slot 604. In some embodiments, slots 104, 114, 122, and 604 may be longer, allowing for raising the scissor jack assembly higher than the illustrated adjusted fire tray maximum height 113.

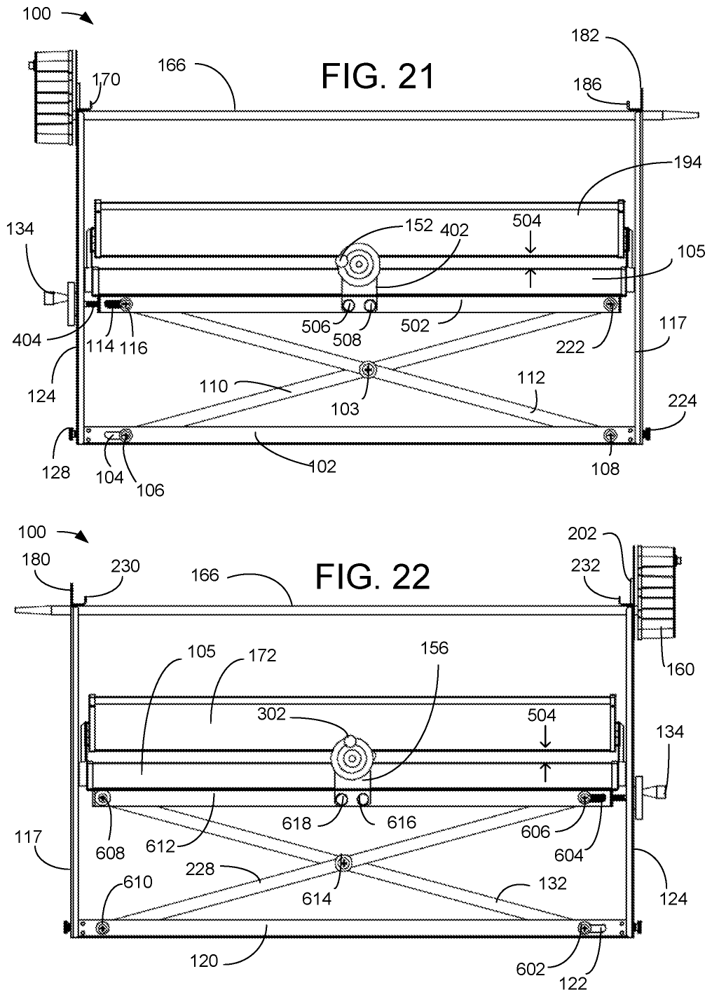

FIG. 21 is a right side elevation view illustrating the exemplary first embodiment of the barbeque cooker 100 of FIG. 1 in the third configuration, according to a preferred embodiment of the present invention. The right-hand upright long side of drip tray 105 can be seen in this view.

FIG. 22 is a left side elevation view illustrating the exemplary first embodiment of the barbeque cooker 100 of FIG. 1 in the third configuration, according to a preferred embodiment of the present invention. The left-hand upright long side of drip tray 105 can be seen in this view.

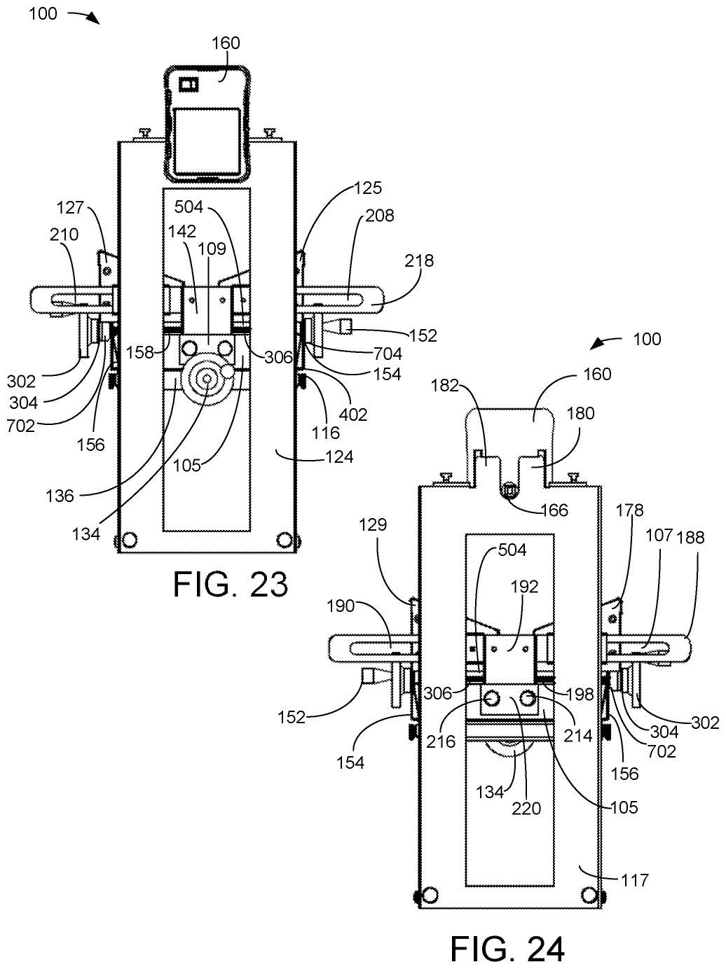

FIG. 23 is a front elevation view illustrating the exemplary first embodiment of the barbeque cooker 100 of FIG. 1 in the third configuration, according to a preferred embodiment of the present invention. In this third configuration, the left fire tray hand crank outer support bracket 304 is in closest proximity to the left horizontal position hand crank screw inner support bracket 156. Likewise, right fire tray hand crank screw outer support bracket 154 is in closest proximity to right horizontal position hand crank inner screw bracket 402. The front upright end of drip tray 105 can be seen in this view. Front fire tray assembly pillar 142 is shown attached to front fire tray support member 218 and received by front fire tray receiver 109, which is attached to the front upright end of drip tray 105. The vertical length of front fire tray assembly pillar 142 establishes the extent of vertical space 504.

FIG. 24 is a rear elevation view illustrating the exemplary first embodiment of the barbeque cooker 100 of FIG. 1 in the third configuration, according to a preferred embodiment of the present invention. The rear upright end of drip tray 105 can be seen in this view. Rear fire tray assembly pillar 192 is shown attached to the rear fire tray support member 188 and received by rear fire tray receiver 220, which is attached to the rear upright end of drip tray 105 via left rear fire tray assembly fastener 214 and right rear fire tray assembly fastener 216. The vertical length of rear fire tray assembly pillar 192 establishes the extent of vertical space 504. It is preferred that front fire tray assembly pillar 142 and rear fire tray assembly pillar 192 have the same vertical length.

FIG. 25 is a front/side perspective view illustrating the exemplary first embodiment of the barbeque cooker 100 of FIG. 1 in a fourth configuration, according to a preferred embodiment of the present invention. In the fourth configuration, the rotisserie 160 has been replaced by grill 2502. Fire tray assembly 123 is shown elevated o scissor jack assembly 121 to an adjusted fire tray maximum height 113 and a fire tray minimum horizontal spacing 904. Grill 2502 is supported by front right grill support 168, left front grill support flange 234, rear right grill support flange 184, and left rear grill support flange 242 and is secured in place by front right gill retainer 170, left front grill retainer 232, rear right grill retainer 186, and left rear grill retainer 230, respectively. In a particular embodiment, retainers 170, 232, 186, and 230 include vertical threaded rods, extending from supports 168, 234, 184, and 242, respectively, with complimentary wing nuts. Those of skill in the art, enlightened by this disclosure, will be aware of the many ways that retainers 170, 232, 186, and 230 may be accomplished, all of which are within the scope of the present invention. The centerline of grill 2502 need not be aligned to a centerline 1902 of the barbeque cooker 100.

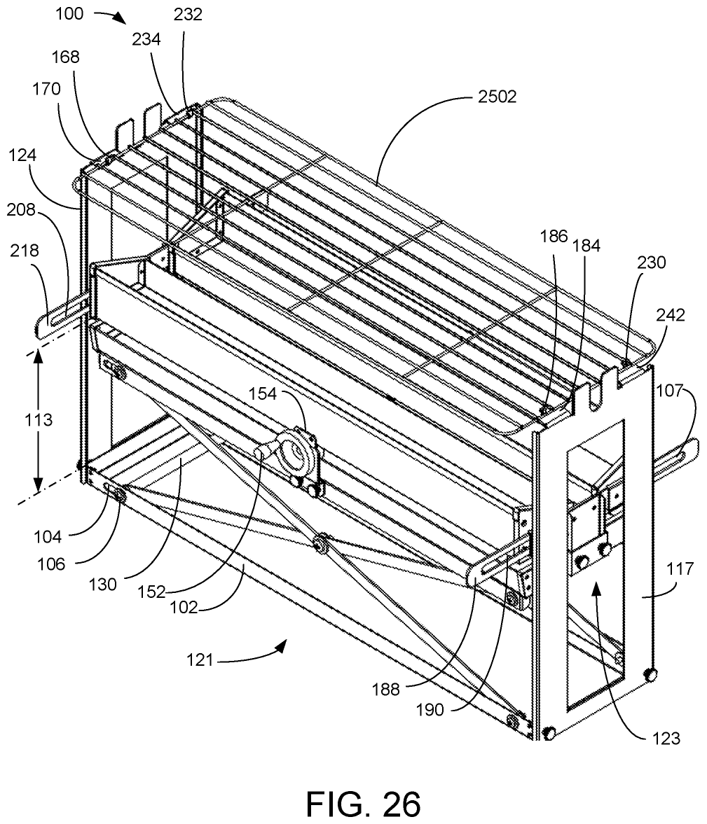

FIG. 26 is a rear/side perspective view illustrating the exemplary first embodiment of the barbeque cooker 100 of FIG. 1 in the fourth configuration, according to a preferred embodiment of the present invention. This view is shown for completeness and contains no new parts.

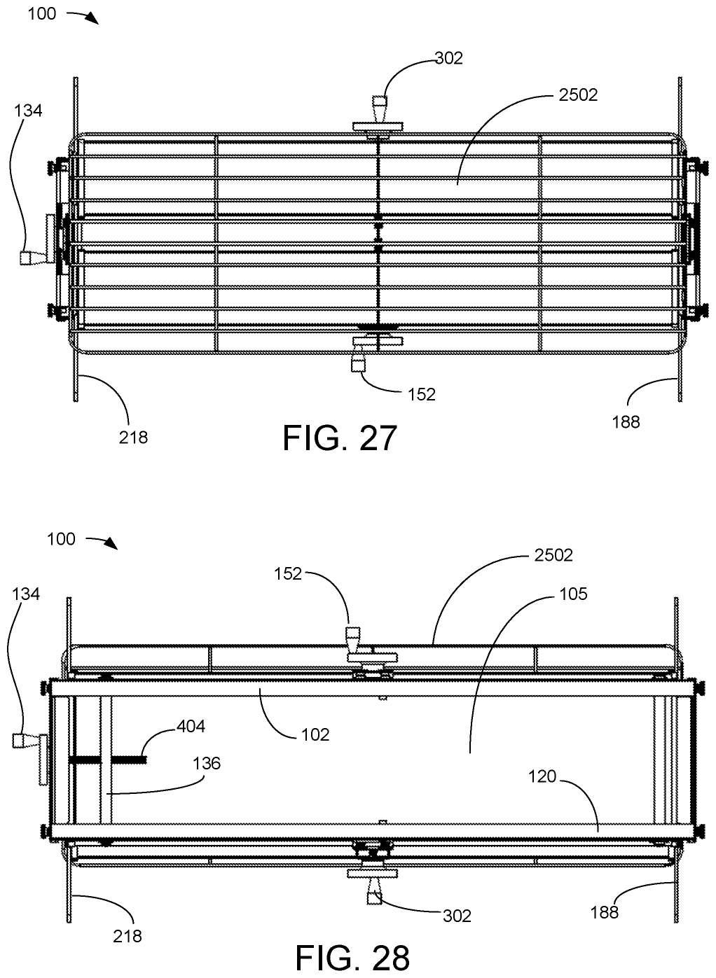

FIG. 27 is a top plan view illustrating the exemplary first embodiment of the barbeque cooker 100 of FIG. 1 in the fourth configuration, according to a preferred embodiment of the present invention. The asymmetric positioning of grill 2502 relative to the fire tray assembly 123 can be seen in this view.

FIG. 28 is a bottom plan view illustrating the exemplary first embodiment of the barbeque cooker 100 of FIG. 1 in the fourth configuration, according to a preferred embodiment of the present invention. The asymmetric positioning of grill 2502 relative to the fire tray assembly 123 can also be seen in this view.

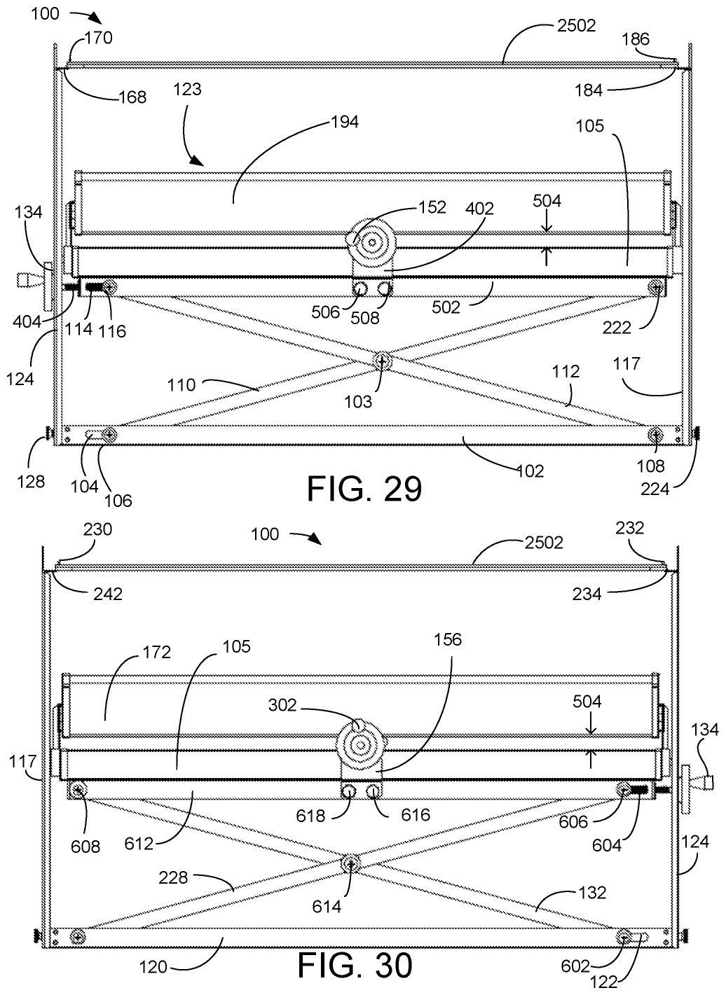

FIG. 29 is a right-side elevation view illustrating the exemplary embodiment of the barbeque cooker of FIG. 1 in the fourth configuration, according to a preferred embodiment of the present invention. In a particular embodiment, additional supports 168 and 184 may be added to the inner sides of front end frame 124 and rear end frame 117, respectively, to enable placing the grill 2502 closer to the fire tray assembly 123.

FIG. 30 is a left side elevation view illustrating the exemplary embodiment of the barbeque cooker of FIG. 1 in the fourth configuration, according to a preferred embodiment of the present invention. In a particular embodiment, additional supports 242 and 234 may be added to the inner sides of rear end frame 117 and front end frame 124, respectively, to enable placing the grill 2502 closer to the fire tray assembly 123.

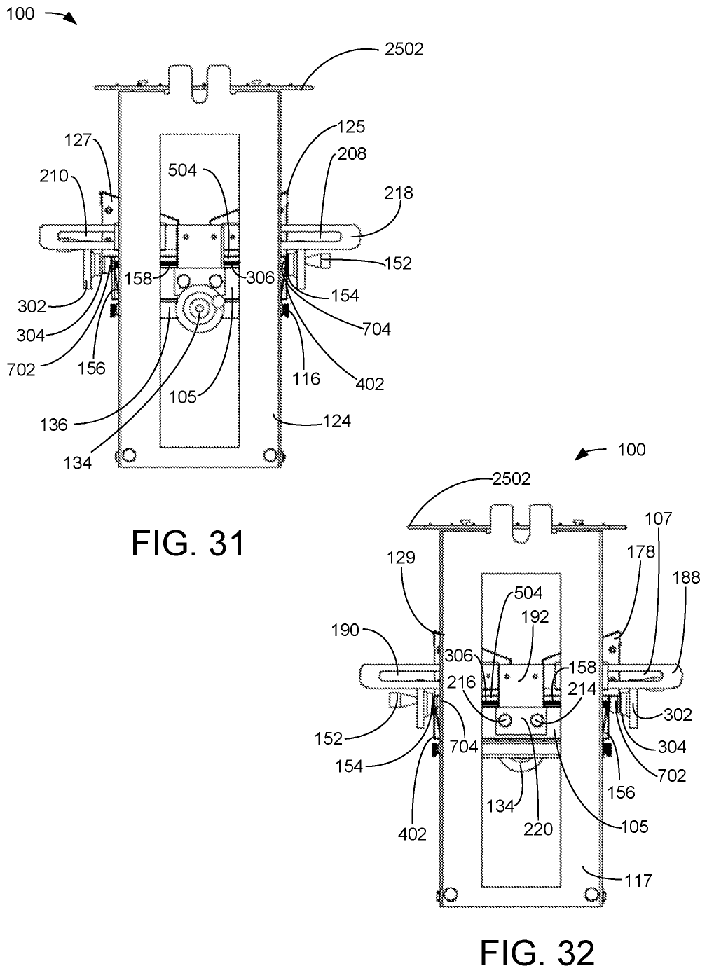

FIG. 31 is a front elevation view illustrating the exemplary first embodiment of the barbeque cooker 100 of FIG. 1 in the fourth configuration, according to a preferred embodiment of the present invention. Other than the substitution of the grill 2502 for the rotisserie 160, this is the same fire tray assembly 123 configuration as in FIG. 23.

FIG. 32 is a rear elevation view illustrating the first exemplary embodiment of the barbeque cooker 100 of FIG. 1 in the fourth configuration, according to a preferred embodiment of the present invention. Other than the substitution of the grill 2502 for the rotisserie 160, this is the same fire tray assembly 123 configuration as in FIG. 24.

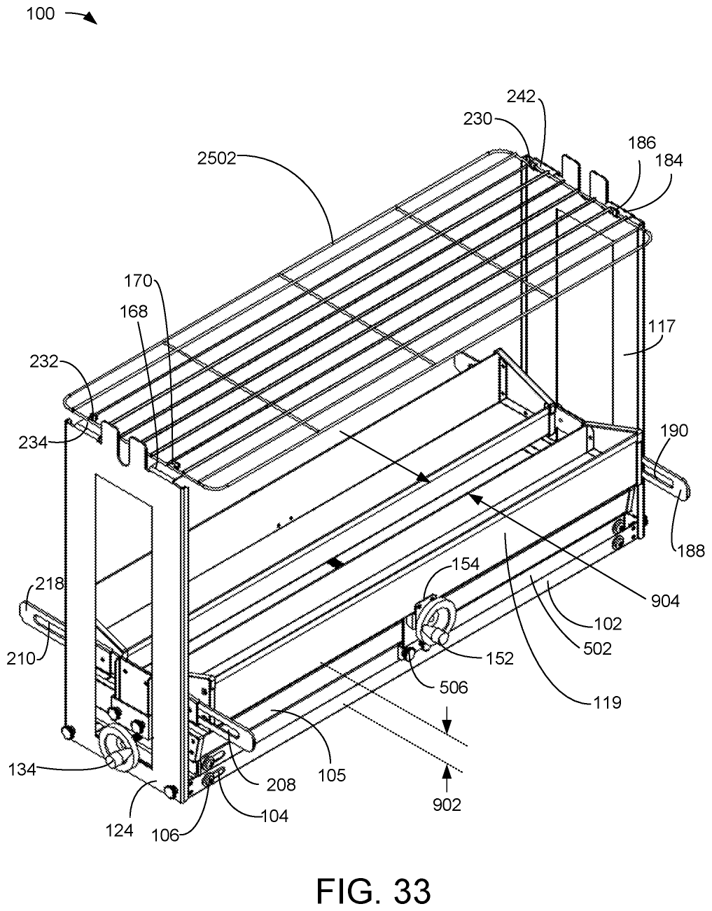

FIG. 33 is a front/side perspective view illustrating exemplary first embodiment of the barbeque cooker 100 of FIG. 1 in a fifth configuration, according to a preferred embodiment of the present invention. The fifth configuration includes adjusted fire tray minimum height 902, fire tray minimum horizontal spacing 904, and a grill 2502 substituted for the rotisserie 160. The illustrated configurations are not limitations of the present invention, as any intermediate vertical and horizontal positions of the fire trays 101 and 119 may be accomplished within the scope of the present invention.

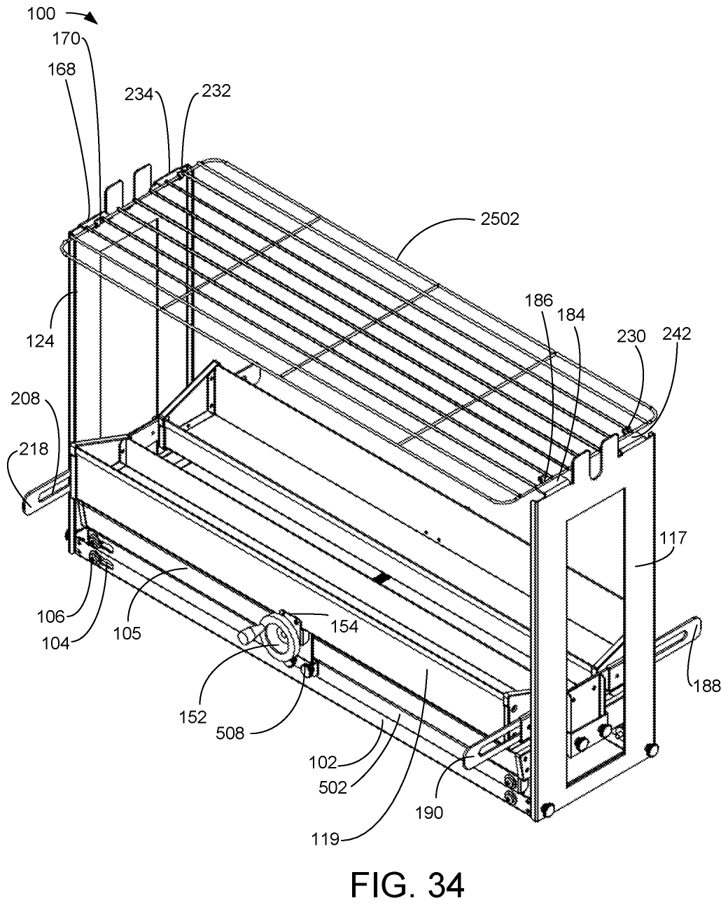

FIG. 34 is a rear/side perspective view illustrating the exemplary first embodiment of the barbeque cooker 100 of FIG. 1 in the fifth configuration, according to a preferred embodiment of the present invention. This view is shown for completeness and contains no new parts.

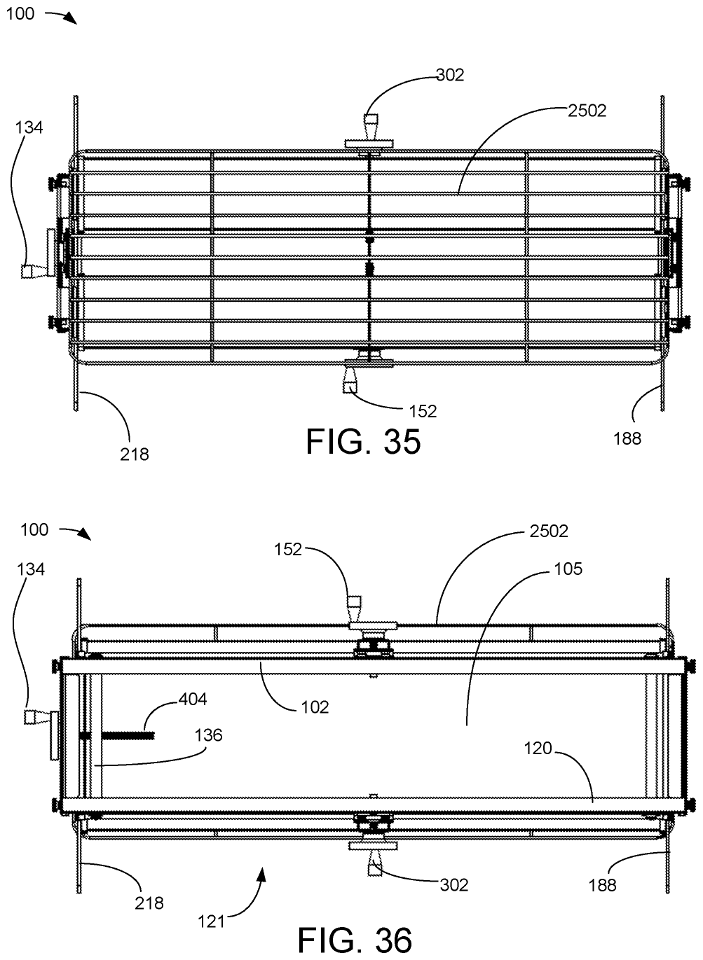

FIG. 35 is atop plan view illustrating the exemplary first embodiment of the barbeque cooker 100 of FIG. 1 in the fifth configuration, according to a preferred embodiment of the present invention. The asymmetric positioning of grill 2502 relative to the fire tray assembly 123 can be seen in this view. The rectangular shape of the grill 2500 is not a limitation of the present invention. As the asymmetric positioning of the grill 2502 suggests, extensions of various sorts may be added to grill 2502. Likewise, the rectangular grid of bars making up the grill 2502 is not limitation of the present invention. For non-limiting example, a planar grill with hexagonal bars, like a honey comb, may be used. Those of skill in the art, enlightened by the present disclosure, will be aware of the many patterns in which grills 2502 may be made, all of wich are within the scope of the present invention.

FIG. 36 is a bottom plan view illustrating the exemplary first embodiment of the barbeque cooker 100 of FIG. 1 in the fifth configuration, according to a preferred embodiment of the present invention. The asymmetric positioning of grill 2502 relative to the scissor jack assembly 121 can be seen in this view.

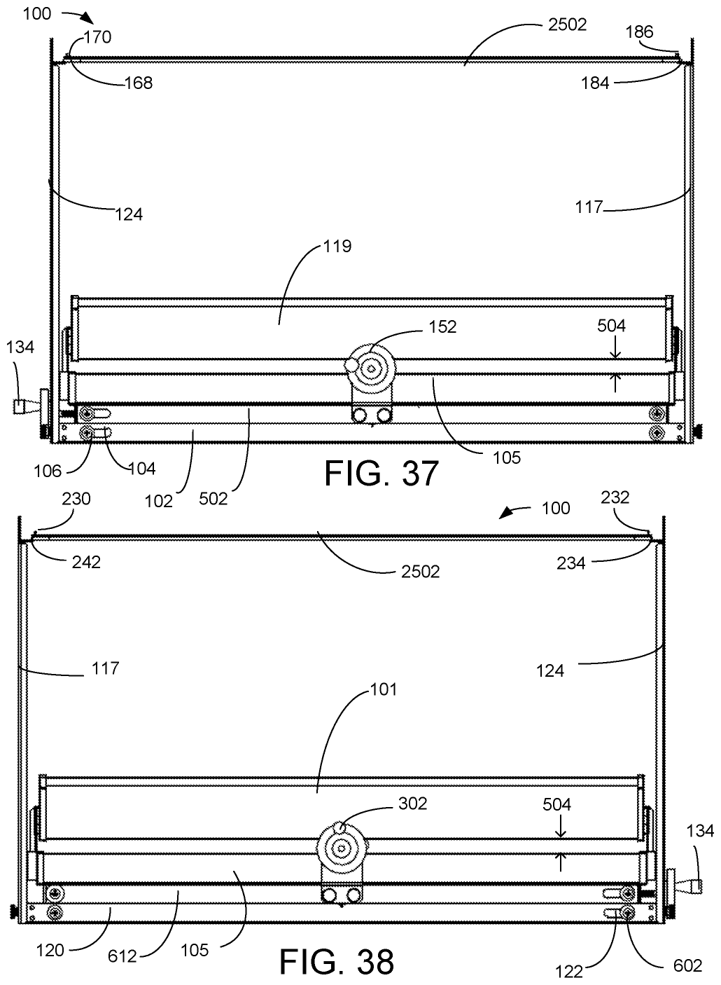

FIG. 37 is a right-side elevation view illustrating the exemplary first embodiment of the barbeque cooker 100 of FIG. 1 in the fifth configuration, according to a preferred embodiment of the present invention. Front right grill support 168 can be seen supporting grill 2502 and front right gill retainer 170 can be seen protruding through grill 2502. Rear right grill support flange 184 can be seen supporting grill 2502 and rear right grill retainer 186 can be seen protruding through grill 2502.

FIG. 38 is a left side elevation view illustrating the exemplary first embodiment of the barbeque cooker 100 of FIG. 1 in the fifth configuration, according to a preferred embodiment of the present invention. Left rear grill support flange 242 can be seen supporting grill 2502 and left rear grill retainer 230 can be seen protruding through grill 2502. Left front grill support flange 234 can be seen supporting grill 2502 and left front grill retainer 232 can be seen protruding through grill 2502.

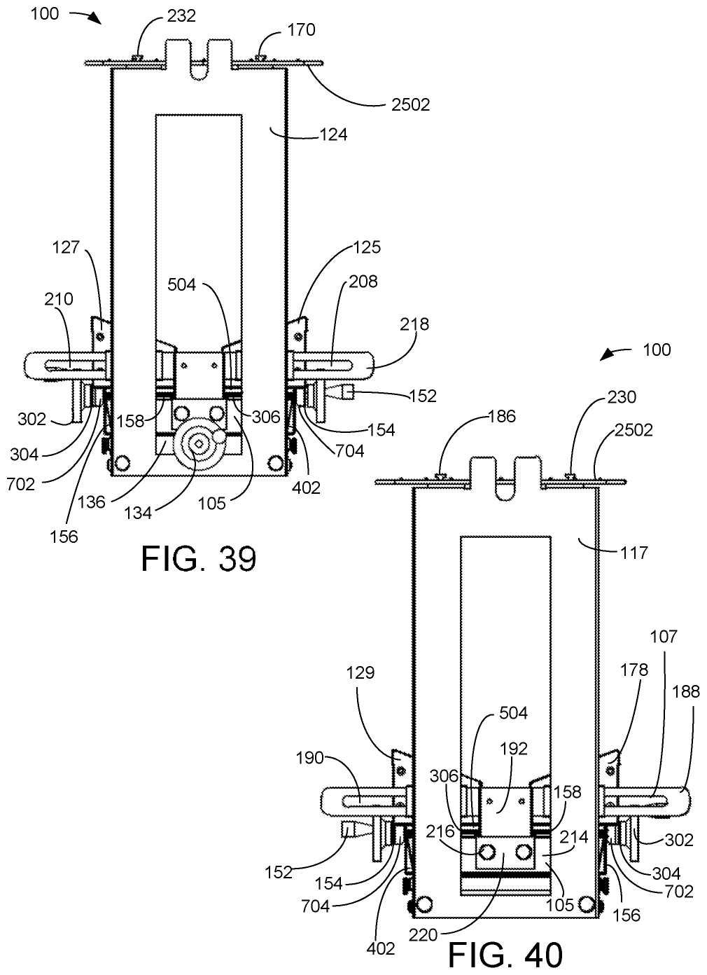

FIG. 39 is a front elevation view illustrating the exemplary first embodiment of the barbeque cooker 100 of FIG. 1 in the fifth configuration, according to a preferred embodiment of the present invention. Left front grill retainer 232 and front right gill retainer 170 can be seen protruding through grill 2502.

FIG. 40 is a rear elevation view illustrating the exemplary embodiment of the barbeque cooker 100 of FIG. 1 in the fifth configuration, according to a preferred embodiment of the present invention. Rear right grill retainer 186 and left rear grill retainer 230 can be seen protruding through grill 2502.

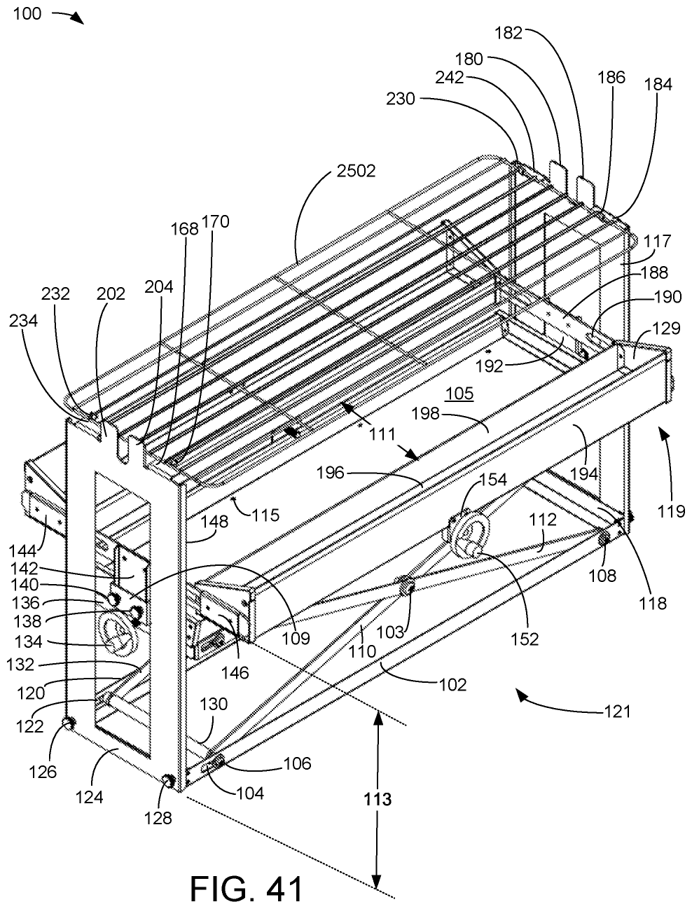

FIG. 41 is a front/side perspective view illustrating the exemplary first embodiment of the barbeque cooker 100 of FIG. 1 in a sixth configuration, according to a preferred embodiment of the present invention. In the sixth configuration, the fire tray assembly is at adjusted fire tray maximum height 113 and fire trays 101 and 119 are at fire tray maximum separation distance 111. Front right grill support 168 and left front grill support flange 234 are preferably of one piece with front end frame 124, and are formed by bending respective portions of the metal of which front end frame 124 is made. Rear right grill support flange 184 and left rear grill support flange 242 are preferably of one piece with rear end frame 117, and are formed by bending respective portions of the metal of which rear end frame 117 is made.

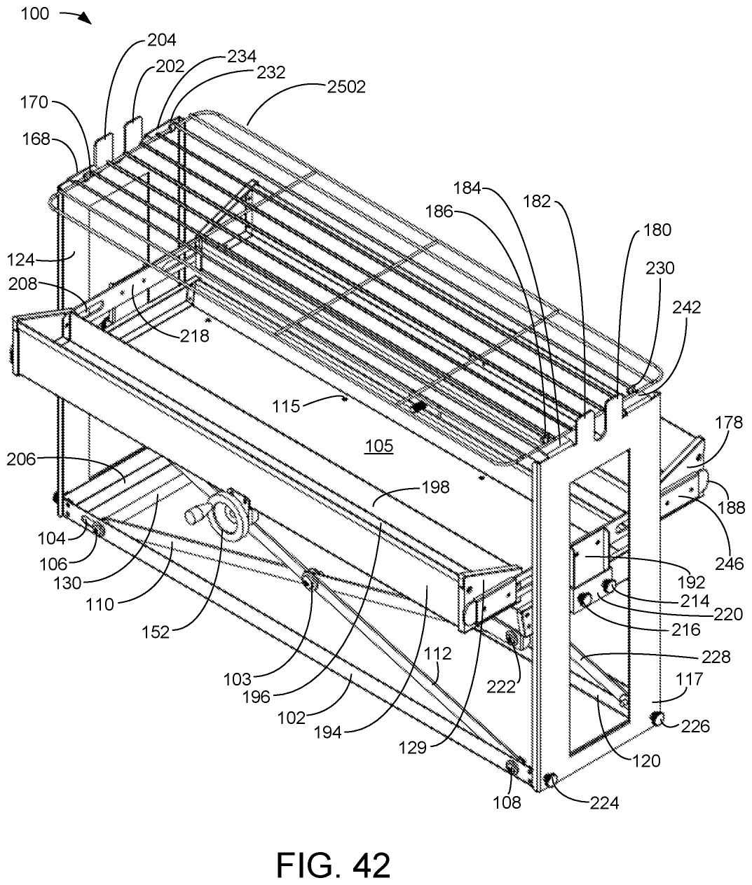

FIG. 42 is a rear/side perspective view illustrating the exemplary first embodiment of the barbeque cooker 100 of FIG. 1 in the sixth configuration, according to a preferred embodiment of the present invention. FIG. 42 is provided for completeness of perspective and contains no new parts.

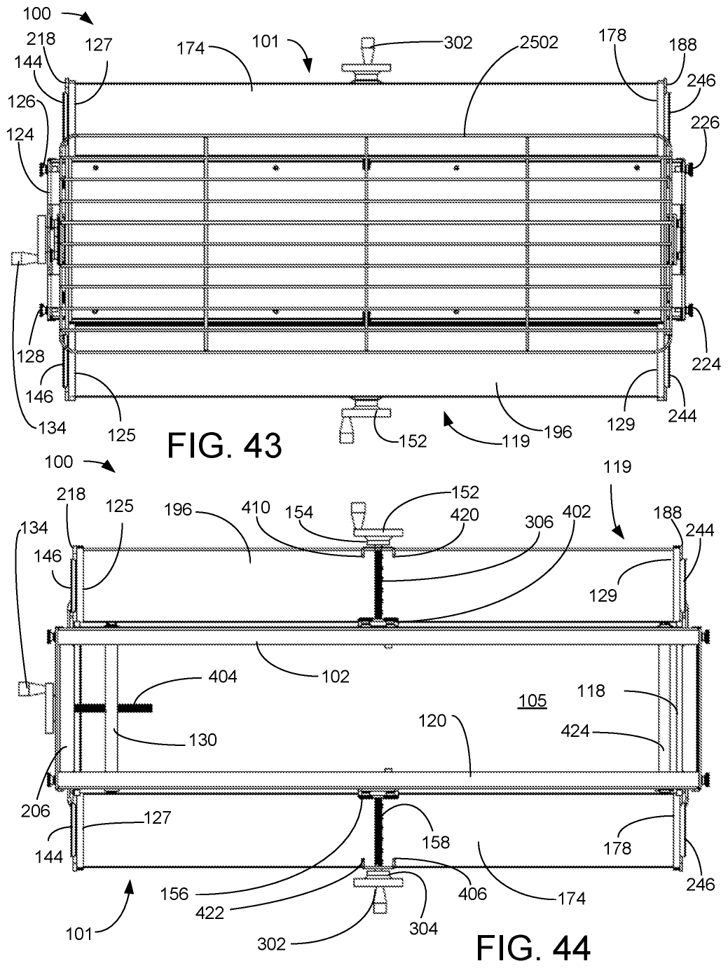

FIG. 43 is a top plan view illustrating the exemplary first embodiment of the barbeque cooker 100 of FIG. 1 in the sixth configuration, according to a preferred embodiment of the present invention. Left front fire tray slider sleeve 144 is shown attached to left fire tray front wall 127 and engaging front fire tray support member 218. Right front fire tray slider sleeve 146 is shown attached to right fire tray front wall 125 and engaging front fire tray support member 218. Left rear fire tray slider sleeve 246 is shown attached to left fire tray rear wall 178 and engaging rear fire tray support member 188. Right rear fire tray slider sleeve 244 is shown attached to right fire tray rear wall 129 and engaging rear fire tray support member 188.

FIG. 44 is a bottom plan view illustrating the first exemplary embodiment of the barbeque cooker 100 of FIG. 1 in the sixth configuration, according to a preferred embodiment of the present invention. Lower slot pin bar 130 occludes the view of upper slot pin bar 136.

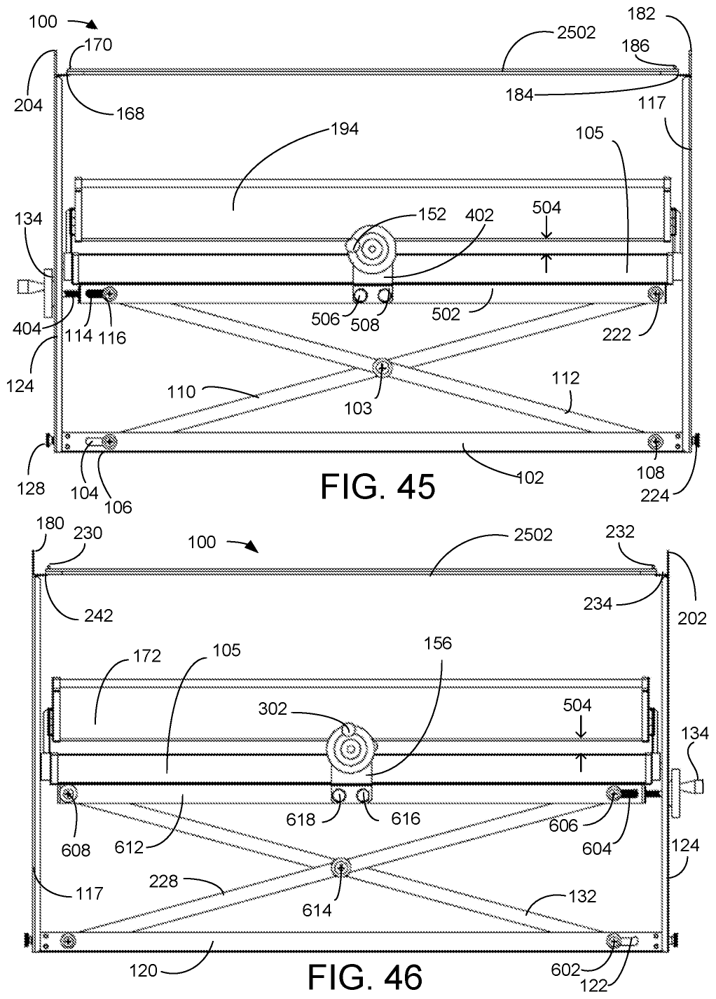

FIG. 45 is a right-side elevation view illustrating the exemplary first embodiment of the barbeque cooker 100 of FIG. 1 in the sixth configuration, according to a preferred embodiment of the present invention. Rear right rotisserie bar retainer 182 and front right rotisserie retainer 204 protrude above the grill 2502.

FIG. 46 is a left side elevation view illustrating the exemplary first embodiment of the barbeque cooker 100 of FIG. 1 in the sixth configuration, according to a preferred embodiment of the present invention. Rear left rotisserie bar retainer 180 and front left rotisserie retainer 202 protrude above the grill 2502.

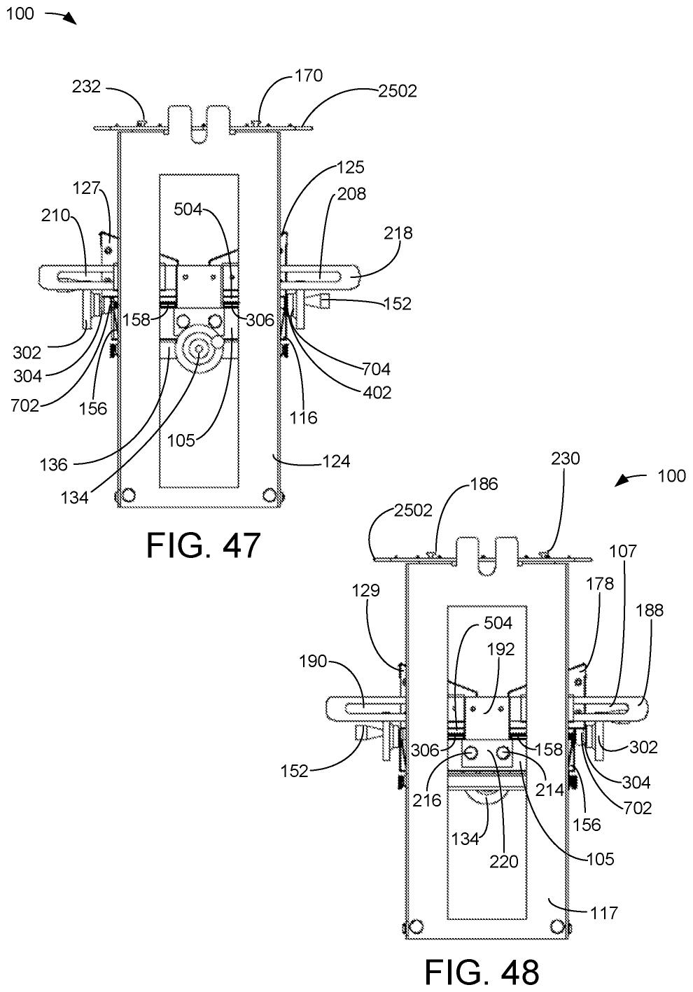

FIG. 47 is a front elevation view illustrating the exemplary first embodiment of the barbeque cooker 100 of FIG. 1 in the sixth configuration, according to a preferred embodiment of the present invention. FIG. 47 is similar to FIG. 39, except for the vertical location of the fire tray assembly 123 and scissor jack assembly 121.

FIG. 48 is a rear elevation view illustrating the first exemplary embodiment of the barbeque cooker 100 of FIG. 1 in the sixth configuration, according to a preferred embodiment of the present invention. FIG. 48 is similar to FIG. 40, except for the vertical location of the fire tray assembly 123 and scissor jack assembly 121.

FIG. 49 is an exploded view illustrating the exemplary first embodiment of the barbeque cooker 100 of FIG. 1 in the sixth configuration, according to a preferred embodiment of the present invention. Barbeque cooker 100 includes a drip tray 105 fastened to a scissor jack assembly 121, a fire tray assembly 123 mountable to the drip tray 105, front end frame 124, rear end frame 117, and grill 2502 or rotisserie 160 (see FIG. 1). Fire tray assembly 123 includes left fire tray 101, right fire tray 119, and front and rear fire tray support members 218 and 188, respectively. Fire trays 101 and 119 hold burning charcoal, wood chips, ethanol gel, and/or other fuels for barbeque cooking.

Right fire tray horizontal position hand crank 152 is supported by two brackets. Left horizontal position hand crank screw inner support bracket 156 is attached to left top long scissor jack assembly angle stock frame member 612 via left fire tray hand crank inner support bracket front fastener 616 and left fire tray hand crank inner support bracket rear fastener 618 through fastener openings analogous to 4914 and 4916 (but not shown), respectively. Left horizontal position hand crank screw inner support bracket 156 has a threaded opening with which left fire tray horizontal position hand crank screw 158 engages. Left fire tray horizontal position hand crank screw 158 extends inwardly through a vertical space 504 between the top of drip tray 105 and the bottom of left fire tray 101. Right fire tray hand crank inner support bracket front fastener 506 and right fire tray inner hand crank support bracket rear fastener 508 secure right horizontal position hand crank inner screw bracket 402 to right top long scissor jack assembly angle stock frame member 502 via fastener openings 4914 and 4916, respectively.

Drip tray 105 is located below the fire tray assembly 123 so that, when desired, the fire trays 101 and 119 may be arranged to avoid fat, basting sauce, and the like from dripping into the fire trays 101 and 119. Front fire tray receiver 109 is secured to a front wall of drip tray 105 via right front fire tray assembly fastener 138 and left fire tray assembly fastener 140, forming a gap between the. Rear fire tray receiver 220 is secured to a rear wall of drip tray 105 via fasteners 214 and 216, forming a gap there between the front fire tray receiver 109 and the front wall of drip tray 105. During assembly, front fire tray assembly pillar 142 slides into the gap between front fire tray receiver 109 and the front wall of drip tray 105. During assembly, rear fire tray assembly pillar 192 slides into the gap between rear fire tray receiver 220 and the rear wall of drip tray 105. Front end frame 124 is secured to scissor jack assembly 121 via fasteners 126 and 128. Rear end frame 117 is secured to scissor jack assembly 121 via fasteners 224 and 226. Grill 2502 rests on grill support flanges 184 (one of four labeled in this view) and is secured with releasable grill retainers 186 (one of four labeled in this view).

The following claims may contain functional claim language and do not contain statements of intended use.

We claim:

1. A barbeque cooker comprising:
a. a scissor jack assembly having a manually adjustable height;
b. a drip pan secured to a top of said scissor jack assembly;
c. a fire tray assembly connected to and vertically spaced apart from said drip pan;
d. front and rear end frames connected to said scissor jack assembly;
e. wherein said front and rear end frames each have top ends comprising a rotisserie support and a grill support, said rotisserie support and said grill support each establishing respective fixed vertical positions for food to be cooked; and
f. wherein said fire tray assembly comprises first and second parallel spaced apart fire trays each having independent horizontal position adjustment apparatus.

2. The barbeque cooker of claim 1, comprising:
a. a first fixed vertical position for said rotisserie supports;
b. a second fixed vertical position for said grill supports; and
c. a front hand crank having a threaded rod extending therefrom, manually operable to adjust said height of said fire tray assembly via said scissor jack assembly.

3. The barbeque cooker of claim 2, wherein said horizontal position adjustment apparatus comprises:
a. an inner right-hand crank screw support bracket attached to a top right member of said scissor jack assembly and extending above said drip tray;
b. an outer right-hand crank screw support bracket attached to an outer wall of said right fire tray and extending below said drip tray;
c. an inner left-hand crank screw support bracket attached to a top left member of said scissor jack assembly and extending above said drip tray; and
d. an outer left-hand crank screw support bracket attached to an outer wall of said left fire tray and extending below said drip tray.

4. The barbeque cooker of claim 3 comprising:
a. a front fire tray support elongated horizontal member, having right and left sides, supported by a front fire tray assembly pillar which is supported in front fire tray receiver which is attached to said drip tray;
b. right and left front fire tray slider slots in respective said right and left sides operable to receive respective right and left front fire tray slider sleeves, each said sleeve having two pins connecting through respective said right and left front fire tray slider slots to respective right and left fire tray front walls;
c. wherein said right and left front fire tray slider sleeves partially envelop and slidingly engage respective right and left ends of said front fire tray support elongated horizontal member.

5. The barbeque cooker of claim 3, comprising:
a. a rear fire tray support elongated horizontal member, having right and left ends, supported by a rear fire tray assembly pillar which is supported in rear fire tray receiver which is attached to said drip tray;
b. right and left rear fire tray slider slots in respective said right and left ends operable to receive respective right and left rear fire tray slider sleeves, each said sleeve having two pins connecting through respective said right and left rear fire tray slider slots to respective right and left fire tray rear walls; and
c. wherein said right and left rear fire tray slider sleeves partially envelop respective right and left ends of said rear fire tray support elongated horizontal member.

6. The barbeque cooker of claim 1, comprising a grill retainer extending upward from each said grill support.

7. The barbeque cooker of claim 6, wherein each said grill retainer comprises a threaded rod and a wing nut.

8. The barbeque cooker of claim 6, comprising a grill configured to be received on said grill supports and releasably attached via said grill retainers.

9. The barbeque cooker of claim 1, comprising a rotisserie configured to be supported by said rotisserie supports.

10. The barbeque cooker of claim 1, wherein said scissor jack assembly, said drip pan, said fire tray assembly, and said end frames comprise iron.

11. A barbeque cooker comprising:
a. first and second fixed vertical positions for food to be cooked on said barbeque cooker; and
b. adjustable vertical and horizontal positions of first and second fire trays, operable to contain respective first and second fires, used to cook such food on said barbeque cooker.

12. The barbeque cooker of claim 11, comprising a scissor jack assembly operable to adjust a vertical spacing between such food and said fire trays.

13. The barbeque cooker of claim 11, comprising a fire tray assembly further comprising:
a. right and left parallel spaced apart fire trays;
b. a right-hand crank driving a right-hand crank screw operable to adjust a horizontal position of said right fire tray; and
c. a left-hand crank driving a left-hand crank screw operable to adjust a horizontal position of said left fire tray.

14. The barbeque cooker of claim 12, comprising:
a. front and rear end frames attached to front and rear ends of said scissor jack assembly, respectively;
b. front and rear rotisserie supports at top ends of said front and rear end frames, respectively;
c. front and rear grill supports at top ends of said front and rear end frames, respectively; and
d. front and rear grill retainers extending upward from said front and rear grill supports, respectively.

15. The barbeque cooker of claim 13, comprising:
a. an inner right-hand crank screw support bracket attached to a top right member of said scissor jack assembly and extending above said drip tray;
b. an outer right-hand crank screw support bracket attached to an outer wall of said right fire tray and extending below said drip tray;
c. an inner left-hand crank screw support bracket attached to a top left member of said scissor jack assembly and extending above said drip tray;
d. an outer left-hand crank screw support bracket attached to an outer wall of said left fire tray and extending below said drip tray.

16. The barbeque cooker of claim 13, wherein:
a. said outer right-hand crank screw support bracket comprises a threaded bore operable to engage said outer right-hand crank screw;
b. said inner right-hand crank screw support bracket comprises a bearing rotationally engaging and axially retaining said inner right-hand crank screw;
c. said outer left-hand crank screw support bracket comprises a threaded bore operable to engage said outer left-hand crank screw; and
d. said inner left-hand crank screw support bracket comprises a bearing rotationally engaging and axially retaining said inner left-hand crank screw.

17. The barbeque cooker of claim 15, wherein:
a. said outer right-hand crank screw support bracket comprises a bearing rotationally engaging said outer right-hand crank screw;
b. said inner right-hand crank screw support bracket comprises a threaded bore operable to engage said outer right-hand crank screw;
c. said outer left-hand crank screw support bracket comprises a bearing rotationally engaging said outer left-hand crank screw; and
d. said inner left-hand crank screw support bracket comprises a threaded bore operable to engage said outer left-hand crank screw.

18. A barbeque cooker comprising:
a. first and second fixed vertical positions for food to be cooked on said barbeque cooker; and
b. adjustable vertical and horizontal positions of first and second fire trays, operable to contain respective first and second fires, used to cook such food on said barbeque cooker;
c. a scissor jack assembly operable to adjust a vertical spacing between such food and said fire trays;
d. a fire tray assembly further comprising:
i. right and left parallel spaced apart fire trays;
ii. a right-hand crank driving a right-hand crank screw operable to adjust a horizontal position of said right fire tray; and
iii. a left-hand crank driving a left-hand crank screw operable to adjust a horizontal position of said left fire tray;
e. front and rear end frames attached to front and rear ends of said scissor jack assembly, respectively;
f. front and rear rotisserie supports at top ends of said front and rear end frames, respectively;
g. front and rear grill supports at top ends of said front and rear end frames, respectively; and
h. front and rear grill retainers extending upward from said front and rear grill supports, respectively.

19. The barbeque cooker of claim 18, comprising:
a. an inner right-hand crank screw support bracket attached to a top right member of said scissor jack assembly and extending above said drip tray;
b. an outer right-hand crank screw support bracket attached to an outer wall of said right fire tray and extending below said drip tray;
c. an inner left-hand crank screw support bracket attached to a top left member of said scissor jack assembly and extending above said drip tray; and
d. an outer left-hand crank screw support bracket attached to an outer wall of said left fire tray and extending below said drip tray.

20. The barbeque cooker of claim 18, wherein:
a. said outer right-hand crank screw support bracket comprises a threaded bore operable to engage said outer right-hand crank screw;
b. said inner right-hand crank screw support bracket comprises a bearing rotationally engaging and axially retaining said inner right-hand crank screw;
c. said outer left-hand crank screw support bracket comprises a threaded bore operable to engage said outer left-hand crank screw; and
d. said inner left-hand crank screw support bracket comprises a bearing rotationally engaging and axially retaining said inner left-hand crank screw.

21. The barbeque cooker of claim 15, wherein:
a. said outer right-hand crank screw support bracket comprises a bearing rotationally engaging said outer right-hand crank screw;
b. said inner right-hand crank screw support bracket comprises a threaded bore operable to engage said outer right-hand crank screw;
c. said outer left-hand crank screw support bracket comprises a bearing rotationally engaging said outer left-hand crank screw; and
d. said inner left-hand crank screw support bracket comprises a threaded bore operable to engage said outer left-hand crank screw.
